(19) United States
(12) Patent Application Publication
(10) Pub. No.: US 2024/0416281 A1
(43) Pub. Date: Dec. 19, 2024

(54) FLUE GAS CONDITIONING

(71) Applicant: Carbon Ridge, Inc., Santa Monica, CA (US)

(72) Inventors: Jorge Mario Plaza Cuellar, The Woodlands, TX (US); Chase Dwyer, Santa Monica, CA (US); Shaojun James Zhou, Cary, NC (US); Aravind Villava Rayer Rabindran, Morrisville, NC (US)

(21) Appl. No.: 18/744,074

(22) Filed: Jun. 14, 2024

Related U.S. Application Data
(60) Provisional application No. 63/508,370, filed on Jun. 15, 2023.

(51) Int. Cl. B01D 53/94; B01D 51/10

(52) U.S. Cl. CPC B01D 53/9481; B01D 51/10; B01D 53/9418; B01D 2252/204; B01D 2257/302; B01D 2257/404; B01D 2258/01; B01D 2259/402; B01D 2259/4566

(57) ABSTRACT

A gas conditioning system removes contaminants including nitrogen oxides and sulfur oxides from flue gas of a marine vessel, and includes an oxidizer unit and a direct contact cooler. The oxidizer unit receives an exhaust flue gas from a marine engine through a fluid inlet at a temperature between 150 degrees Celsius and 550 degrees Celsius, and converts at least a portion of the nitrogen oxides in the flue gas into nitrogen gas, nitrogen dioxide, or both. The direct contact cooler is fluidly connected to the oxidizer unit, and includes a housing defining a cooling chamber. The direct contact cooler directs the flue gas into contact with seawater residing in the cooling chamber and cools the flue gas to a temperature less than or equal to 60 degrees Celsius. The seawater removes some or all nitrogen dioxide and sulfur dioxide from the flue gas in the cooling chamber.

### CROSS-REFERENCE TO RELATED APPLICATIONS

This application claims the benefit of U.S. Provisional Application No. 63/508,370, filed on Jun. 15, 2023, the entirety of which is herein incorporated by reference.

### TECHNICAL FIELD

This disclosure relates to gas conditioning, such as conditioning systems for flue gas.

### BACKGROUND

Fuel-fed engines, such as marine diesel engines, produce exhaust gases with a variety of pollutants. In marine diesel engines, these pollutants include nitrogen oxides, sulfur oxides, and carbon dioxide. US and international regulations aim to limit the concentration of certain pollutants that can be expelled by marine diesel engines.

### SUMMARY

This disclosure describes gas conditioning systems, such as flue gas conditioning systems for flue gas from marine vessels.

In some aspects, a gas conditioning system for removing contaminants including nitrogen oxides and sulfur oxides from flue gas of a marine vessel includes an oxidizer unit comprising a first fluid inlet and a first fluid outlet, where the oxidizer unit receives an exhaust flue gas from a marine engine through the first fluid inlet at a temperature between 150 degrees Celsius and 550 degrees Celsius. The oxidizer unit converts at least a portion of the nitrogen oxides in the flue gas into at least one of nitrogen gas or nitrogen dioxide at a temperature between 150 degrees Celsius and 550 degrees Celsius. The gas conditioning system also includes a direct contact cooler comprising a second fluid inlet fluidly connected to the first fluid outlet of the oxidizer unit, a housing defining a cooling chamber, and a second fluid outlet. The direct contact cooler directs the flue gas into contact with seawater residing in the cooling chamber and cools the flue gas to a temperature less than or equal to 60 degrees Celsius. The seawater removes the nitrogen dioxide and sulfur dioxide from the flue gas in the cooling chamber.

This, and other aspects, can include one or more of the following features. The oxidizer unit can receive the exhaust flue gas from the marine engine through the first fluid inlet at a temperature between 150 degrees Celsius and 350 degrees Celsius, and the oxidizer unit can convert the at least a portion of the nitrogen oxides in the flue gas into the at least one of nitrogen gas or nitrogen dioxide at a temperature between 150 degrees Celsius and 350 degrees Celsius. The direct contact cooler can cool the flue gas to a temperature less than or equal to 50 degrees Celsius. The oxidizer unit can receive the exhaust flue gas from the marine engine through the first fluid inlet at a temperature between 150 degrees Celsius and 310 degrees Celsius, and the oxidizer unit can convert the at least a portion of the nitrogen oxides in the flue gas into the at least one of nitrogen gas or nitrogen dioxide at a temperature between 150 degrees Celsius and 310 degrees Celsius. The oxidizer unit can convert at least a portion of the sulfur oxides in the flue gas into sulfur dioxide at the temperature between 150 degrees Celsius and 550 degrees Celsius, and the direct contact cooler can separate the nitrogen dioxide and sulfur dioxide from the flue gas in the cooling chamber. The oxidizer unit can include a housing defining an oxidizing chamber and an oxidizing agent residing in the oxidizing chamber, the oxidizing agent to directly contact the exhaust flue gas. The oxidizing agent can include a solution of sodium chlorite, hydrogen peroxide, or sodium hypochlorite, which contacts the flue gas and converts at least a portion of nitrogen oxide in the flue gas into at least one of nitrogen gas or nitrogen dioxide. The oxidizer unit can include a selective catalytic reduction unit to convert the portion of the nitrogen oxides into at least one of nitrogen gas or nitrogen dioxide at the temperature between 150 degrees Celsius and 550 degrees Celsius. The gas conditioning system can further include an adsorption unit comprising a third fluid inlet fluidly connected to the second fluid outlet of the direct contact cooler, the adsorption unit to receive the flue gas from the direct contact cooler and remove at least a portion of remaining nitrogen oxides from the flue gas from the direct contact cooler. The adsorption unit can include at least one adsorption bed, the gas conditioning system can direct the flue gas from the third fluid inlet through the at least one adsorption bed, and the adsorption bed can reduce a nitrogen oxide content from the flue gas to less than 50 parts per million. The adsorption bed can reduce the nitrogen oxide content from the flue gas to less than 10 parts per million. The adsorption unit can include two adsorption beds. The selective catalytic reduction unit can include a second housing defining a second chamber, and a compound inlet to introduce a mist of compound solution into the second chamber, and the first fluid inlet can direct the flue gas into contact with the compound solution in the second chamber. The compound solution can include urea or ammonia. The selective catalytic reduction unit can include a catalyst disposed in the second chamber, where the catalyst contacts the flue gas and the mist of compound solution. The gas conditioning system can further include a filter positioned upstream of the first fluid inlet, where the filter removes particulate matter and volatile hydrocarbons from the flue gas. The filter can be directly coupled to the oxidizer unit at the first fluid inlet of the oxidizer unit. The gas conditioning system can further include a blower unit positioned between a marine engine and the first fluid inlet of the oxidizer unit, where the blower unit directs the flue gas to the oxidizer unit and increases the pressure of the flue gas. The gas conditioning system can further include a blower unit positioned downstream of the direct contact cooler, where the blower unit generates a partial vacuum in a flowpath of the flue gas through the oxidizer and the direct contact cooler and promotes flow of the flue gas through the oxidizer and the direct contact cooler and toward the blower unit. The direct contact cooler can include a rotating packed bed comprising the housing enclosing the cooling chamber, a rotor drum disposed within the housing and rotatable about a rotational axis, a seawater inlet fluidly connected to the rotor drum, a seawater outlet fluidly connected to the housing, the second fluid inlet fluidly connected to the housing, and the second fluid outlet fluidly connected to the rotor drum, where the flue gas is directed from the second fluid inlet to the second fluid outlet, and seawater is directed from the seawater inlet to the seawater outlet. The flue gas can be disposed in countercurrent flow with the seawater within the rotor drum when the rotating packed bed is in use. The direct contact cooler can include a seawater inlet to direct the seawater into the cooling chamber, where the seawater removes at least a portion of sulfur dioxide and nitrogen dioxide from the flue gas in the cooling chamber. The gas conditioning system can further include a water treatment system fluidly connected to the direct contact cooler to receive the seawater from the direct contact cooler, where the water treatment system includes a membrane and a dosification system to adjust the pH of the seawater to be above 6.5. The gas conditioning system can further include a rotating packed bed assembly fluidly connected to the direct contact cooler to receive the flue gas from the direct contact cooler, and the rotating packed bed assembly can include a first rotating packed bed having an absorption agent to absorb at least a portion of carbon dioxide from the flue gas, and a second rotating packed bed to receive the absorption agent from the first rotating packed bed and desorb the absorbed carbon dioxide from the absorption agent. The absorption agent can include a liquid solvent. The liquid solvent can include an amine solvent. The rotating packed bed assembly can include a water wash station fluidly connected to the first rotating packed bed, where the water wash station washes the fluc gas from the first rotating packed bed with water. The water wash station can include a packed cylinder or a rotating packed bed. The gas conditioning system can further include a storage system fluidly connected to the second rotating packed bed and including a compressor and a storage tank, and the storage system receives desorbed carbon dioxide, compresses the desorbed carbon dioxide with the compressor, and stores the carbon dioxide in the storage tank.

Certain aspects of the disclosure encompass a method for conditioning flue gas from a marine vessel. The method includes receiving, at a chamber of an oxidizer unit, an exhaust flue gas from a marine engine at a temperature between 150 degrees Celsius and 550 degrees Celsius, converting, with a reactant in the chamber of the oxidizer unit, a portion of the nitrogen oxides in the flue gas into at least one of nitrogen gas or nitrogen dioxide at a temperature between 150 degrees Celsius and 550 degrees Celsius, receiving, at a direct contact cooler, the flue gas from the oxidizer unit, and cooling, with direct contact of the flue gas with seawater in the direct contact cooler, the flue gas to a temperature less than or equal to 60 degrees Celsius.

These, and other aspects, can include one or more of the following features. The exhaust flue gas can be received from the marine engine at a temperature between 150 degrees Celsius and 350 degrees Celsius, and the portion of nitrogen oxides are converted at a temperature between 150 degrees Celsius and 350 degrees Celsius. Converting, with the reactant in the chamber of the oxidizer unit, can further include converting a portion of the sulfur oxides in the flue gas into sulfur dioxide, and cooling the flue gas with seawater can include, in response to the direct contact of the flue gas with the seawater, removing, with the seawater, at least a portion of the sulfur dioxide and the nitrogen dioxide from the flue gas. The oxidizer unit can include a selective catalytic reduction unit, and the converting can include converting the portion of the nitrogen oxides in the flue gas into at least one of nitrogen gas or nitrogen dioxide at the temperature between 150 degrees Celsius and 550 degrees Celsius. The reactant can include a catalyst, and converting the portion of the nitrogen oxides in the flue gas into at least one of nitrogen gas or nitrogen dioxide can include directing the flue gas into contact with a mist of compound solution in the chamber and further directing the flue gas and the mist of compound solution toward the catalyst in the chamber. The compound solution can include a urea solution or an ammonia solution. The method can further include receiving, at an adsorption unit, the cooled flue gas from the direct contact cooler, and removing, at the adsorption unit, at least a portion of remaining nitrogen oxides from the cooled flue gas. Removing at least a portion of remaining nitrogen oxides from the cooled flue gas can include directing the cooled flue gas through at least one adsorption bed of the adsorption unit to reduce a nitrogen oxide content of the flue gas to less than 50 parts per million, for example, less than 10 parts per million. The method can further include increasing a pressure of the flue gas with a blower unit positioned between the marine engine and the oxidizer unit, and directing, with the blower unit, the flue gas to the oxidizer unit. The method can further include generating a partial vacuum in a flowpath of the flue gas through the oxidizer unit and the direct contact cooler with a blower unit positioned downstream of the direct contact cooler, and directing, with the blower unit, the flue gas to flow through the oxidizer unit and the blower unit and toward the blower unit. The method can further include filtering, with a filter positioned upstream of the oxidizer unit, particulate matter and volatile hydrocarbons from the flue gas. The direct contact cooler can include a rotating packed bed, and cooling the flue gas can include directing the flue gas in the rotating packed bed into countercurrent flow with the seawater in the rotating packed bed. Directing the flue gas in the rotating packed bed into countercurrent flow with the seawater in the rotating packed bed can include transferring at least a portion of sulfur dioxide and nitrogen dioxide in the flue gas to the seawater. The method can further include directing the flue gas from the direct contact cooler to a first rotating packed bed including an absorption agent, and absorbing, with the absorption agent in the first rotating packed bed, at least a portion of carbon dioxide from the flue gas. The method can further include directing the absorption agent with the absorbed carbon dioxide to a second rotating packed bed, and desorbing, in the second rotating packed bed, the absorbed carbon dioxide from the absorption agent. The method can further include directing the desorbed carbon dioxide to a storage system, compressing, with a compressor of the storage system, the carbon dioxide, and storing, with a storage tank of the storage system, the compressed carbon dioxide. The method can further include directing the flue gas from the first rotating packed bed to a water wash station including a housing enclosing a wash chamber, and washing, in the wash chamber of the water wash station, the flue gas with water. Receiving the exhaust flue gas from the marine engine can include receiving the exhaust flue gas at a temperature less than or equal to 250 degrees Celsius, and converting the portion of the nitrogen oxides in the flue gas into at least one of nitrogen gas or nitrogen dioxide can include converting at a temperature of the flue gas that is less than or equal to 250 degrees Celsius.

Some aspects of the disclosure encompass a gas conditioning system for removing contaminants comprising nitrogen oxides and sulfur oxides from flue gas of a marine vessel. The gas conditioning system includes an oxidizer unit having a first fluid inlet and a first fluid outlet, the oxidizer unit to receive an exhaust flue gas through the first fluid inlet, and the oxidizer unit to convert at least a portion of the nitrogen oxides in the flue gas into at least one of nitrogen gas or nitrogen dioxide, and a direct contact cooler having a rotating packed bed to direct the flue gas into contact with seawater and cool the flue gas to a temperature less than or equal to 60 degrees Celsius. The seawater is to remove the nitrogen dioxide and sulfur dioxide from the flue gas. The rotating packed bed includes a housing enclosing a cooling chamber, a rotor drum that is disposed within the housing and is rotatable about a rotational axis, a seawater inlet fluidly connected to the rotor drum, a seawater outlet fluidly connected to the housing, a second fluid inlet fluidly connected to the housing and to the first fluid outlet of the oxidizer unit, and a second fluid outlet fluidly connected to the rotor drum. The flue gas is directed from the second fluid inlet to the second fluid outlet, and the seawater is directed from the seawater inlet to the seawater outlet.

This, and other aspects, can include one or more of the following features. The flue gas can be disposed in countercurrent flow with the seawater within the rotor drum when the rotating packed bed is in use. The seawater inlet directs the seawater into the rotor drum, and the seawater removes at least a portion of the sulfur dioxide and the nitrogen dioxide from the flue gas in the cooling chamber. The oxidizer unit can include a selective catalytic reduction unit, and the selective catalytic reduction unit can receive the exhaust flue gas at a temperature between 150 degrees Celsius and 350 degrees Celsius and converts the portion of the nitrogen oxides in the flue gas into nitrogen gas at a temperature between 150 degrees Celsius and 350 degrees Celsius. The selective catalytic reduction unit can include a second housing defining a second chamber, and a compound inlet to introduce a mist of a compound solution into the second chamber, where the first fluid inlet directs the flue gas into contact with the mist of compound solution in the second chamber. The compound solution can include urea or ammonia. The selective catalytic reduction unit can include a catalyst disposed in the second chamber, the catalyst to contact the flue gas and the mist of compound solution in the second chamber. The gas conditioning system can further include an adsorption unit having a third fluid inlet fluidly connected to the second fluid outlet of the direct contact cooler, where the adsorption unit receives the flue gas from the direct contact cooler and removes at least a portion of remaining nitrogen oxides from the flue gas from the direct contact cooler. The adsorption unit can include at least one adsorption bed, the gas conditioning system directs the flue gas from the third fluid inlet through the at least one adsorption bed, and the adsorption bed reduces a nitrogen oxide content from the flue gas to less than 10 parts per million. The adsorption unit can include two adsorption beds. The gas conditioning system can further include a filter positioned upstream of the first fluid inlet, where the filter removes particulate matter and volatile hydrocarbons from the flue gas. The filter can be directly coupled to the oxidizer unit at the first fluid inlet of the oxidizer unit. The gas conditioning system can further include a blower unit positioned upstream of the first fluid inlet of the oxidizer unit, where the blower unit directs the flue gas to the oxidizer unit and increases a pressure of the flue gas. The gas conditioning system can further include a blower unit positioned downstream of the direct contact cooler, where blower unit generates a partial vacuum in a flowpath of the flue gas through the oxidizer unit and the direct contact cooler and promotes flow of the flue gas through the oxidizer and the direct contact cooler and toward the blower unit. The gas conditioning system can further include a rotating packed bed assembly fluidly connected to the direct contact cooler to receive the flue gas from the direct contact cooler, where the rotating packed bed assembly includes a first rotating packed bed having an absorption agent to absorb at least a portion of the carbon dioxide from the flue gas, and a second rotating packed bed to receive the absorption agent from the first rotating packed bed and desorb the absorbed carbon dioxide from the absorption agent. The rotating packed bed assembly can further include a water wash station fluidly connected to the first rotating packed bed, where the water wash station washes the flue gas from the first rotating packed bed with water. The water wash station can include a packed cylinder or a rotating packed bed. The gas conditioning system can further include a storage system fluidly connected to the second rotating packed bed and including a compressor and a storage tank, where the storage system receives desorbed carbon dioxide, compresses the desorbed carbon dioxide with the compressor, and stores the carbon dioxide in the storage tank.

Certain aspects of the disclosure encompass a method for conditioning flue gas. The method includes receiving an exhaust flue gas at a chamber of an oxidizer unit, converting a portion of the nitrogen oxides in the flue gas into at least one of nitrogen gas or nitrogen dioxide with a reactant in the chamber of the oxidizer unit, receiving the flue gas from the oxidizer unit at a direct contact cooler, where the direct contact cooler includes a rotating packed bed, and directing the flue gas in the rotating packed bed into contact with seawater in the rotating packed bed to cool the flue gas to a temperature less than or equal to 60 degrees Celsius.

These aspects and other aspects can include one or more of the following features. Converting, with the reactant in the chamber of the oxidizer unit, can further include converting a portion of the sulfur oxides in the flue gas into sulfur dioxide, and directing the flue gas in the rotating packed bed into contact with the seawater in the rotating packed bed can include transferring at least a portion of sulfur dioxide and nitrogen dioxide in the flue gas to the seawater. The directing can include directing the flue gas into countercurrent flow with seawater in the rotating packed bed. The oxidizer unit can include a selective catalytic reduction unit, receiving the exhaust flue gas can include receiving the exhaust flue gas at the chamber of the selective catalytic reduction unit at a temperature between 150 degrees Celsius and 550 degrees Celsius, and converting the portion of nitrogen oxides can include converting the portion of the nitrogen oxides into nitrogen gas at a temperature between 150 degrees Celsius and 550 degrees Celsius, or between 150 degrees Celsius and 350 degrees Celsius. The reactant can include a catalyst, and converting the portion of the nitrogen oxides into nitrogen gas can include directing the flue gas into contact with a mist of compound solution in the chamber and further directing the flue gas and the mist of compound solution toward the catalyst in the chamber. The compound solution can include a urea solution or an ammonia solution. The method can further include receiving, at an adsorption unit, the cooled flue gas from the direct contact cooler, and removing, at the adsorption unit, at least a portion of remaining nitrogen oxides from the cooled flue gas. Removing at least a portion of the remaining nitrogen oxides from the cooled flue gas can include directing the cooled flue gas through at least one adsorption bed of the adsorption unit to reduce a nitrogen oxide content from the flue gas to less than 50 parts per million, or less than 10 parts per million. The method can further include increasing a pressure of the flue gas with a blower unit positioned upstream of the oxidizer unit, and directing, with the blower unit, the flue gas to the oxidizer unit. The method can further include generating a partial vacuum in a flowpath of the flue gas through the oxidizer unit and the direct contact cooler with a blower unit positioned downstream of the direct contact cooler, and directing, with the blower unit, the flue gas to flow through the oxidizer unit and the blower unit and toward the blower unit. The method can further include filtering, with a filter positioned upstream of the oxidizer unit, particulate matter and volatile hydrocarbons from the flue gas. The method can further include directing the flue gas from the direct contact cooler to a first rotating packed bed having an absorption agent, and absorbing, with the absorption agent in the first rotating packed bed, at least a portion of carbon dioxide from the flue gas. The method can further include directing the absorption agent with the absorbed carbon dioxide to a second rotating packed bed, and desorbing, in the second rotating packed bed, the absorbed carbon dioxide from the absorption agent. The method can further include directing the desorbed carbon dioxide to a storage system, compressing, with a compressor of the storage system, the carbon dioxide, and storing, with a storage tank of the storage system, the compressed carbon dioxide. The method can further include directing the flue gas from the first rotating packed bed to a water wash station having a housing enclosing a wash chamber, and washing, in the wash chamber of the water wash station, the flue gas with water.

In some aspects, a gas conditioning system for removing contaminants including nitrogen oxides and sulfur oxides from flue gas of a marine vessel includes a contactor, a direct contact cooler, and an adsorption unit. The contactor includes a contactor housing defining a first chamber, and an oxidizing agent residing in the first chamber, where the contactor receives an exhaust flue gas from a marine engine in the first chamber and directs the flue gas into contact with the oxidizing agent to convert at least a portion of nitrogen oxide in the flue gas into nitrogen dioxide. The direct contact cooler includes a rotating packed bed to receive the exhaust flue gas from the contactor and directs the flue gas into contact with seawater to cool the flue gas to a temperature less than or equal to 60 degrees Celsius. The seawater removes the nitrogen dioxide and sulfur dioxide from the flue gas. The rotating packed bed includes a housing enclosing a cooling chamber, a rotor drum disposed within the housing and rotatable about a rotational axis, a seawater inlet fluidly connected to the rotor drum, a seawater outlet fluidly connected to the housing, a first fluid inlet fluidly connected to the housing, and a first fluid outlet fluidly connected to the rotor drum. The flue gas is directed from the first fluid inlet to the first fluid outlet, and the seawater is directed from the seawater inlet to the seawater outlet. The adsorption unit includes a second fluid inlet fluidly connected to the first fluid outlet of the direct contact cooler, and a packed cylinder. The adsorption unit receives the flue gas from the direct contact cooler and removes at least a portion of remaining nitrogen oxides from the flue gas to reduce a nitrogen oxide content of the flue gas to less than 10 parts per million.

These, and other aspects, can include one or more of the following features. The flue gas can be disposed in countercurrent flow with the seawater within the rotor drum when the rotating packed bed is in use. The seawater inlet can direct the seawater into the rotor drum, and the seawater removes at least a portion of sulfur dioxide and nitrogen dioxide from the flue gas in the cooling chamber. The adsorption unit can include at least one adsorption bed, and the adsorption unit directs the flue gas through the at least one adsorption bed. The oxidizing agent can include a solution of sodium chlorite, hydrogen peroxide, or sodium hypochlorite. The gas conditioning system can further include a rotating packed bed assembly fluidly connected to the adsorption unit to receive the flue gas from the adsorption unit, where the rotating packed bed assembly includes a first rotating packed bed having an absorption agent to absorb at least a portion of the carbon dioxide from the flue gas, and a second rotating packed bed to receive the absorption agent from the first rotating packed bed and desorb the absorbed carbon dioxide from the absorption agent. The rotating packed bed assembly can further include a water wash station fluidly connected to the first rotating packed bed, where the water wash station washes the flue gas from the first rotating packed bed with water. The water wash station can include a packed cylinder or a rotating packed bed. The gas conditioning system can further include a storage system fluidly connected to the second rotating packed bed and including a compressor and a storage tank, where the storage system receives desorbed carbon dioxide, compresses the desorbed carbon dioxide with the compressor, and stores the carbon dioxide in the storage tank.

Certain aspects of the disclosure encompass a method for conditioning flue gas from a marine vessel. The method includes receiving an exhaust flue gas from a marine engine in a first chamber of a contactor, where the contactor includes a contactor housing defining the first chamber and an oxidizing agent residing in the first chamber, and directing the flue gas into contact with the oxidizing agent in the first chamber of the contactor to convert at least a portion of nitrogen oxide in the flue gas into nitrogen dioxide. The method further includes receiving, at a direct contact cooler, the exhaust flue gas from the contactor, where the direct contact cooler includes a rotating packed bed, and directing the flue gas in the rotating packed bed into contact with seawater in the rotating packed bed to cool the flue gas to a temperature less than or equal to 60 degrees Celsius.

These, and other aspects, can include one or more of the following features. The method can further include receiving, at an adsorption unit, the cooled flue gas from the direct contact cooler, and removing, with a packed cylinder of the adsorption unit, a remaining portion of nitrogen oxide from the flue gas. Removing the remaining portion of the nitrogen oxide from the flue gas can include directing the flue gas through at least one adsorption bed of the packed cylinder to reduce a nitrogen oxide content from the flue gas to less than 10 parts per million. Directing the flue gas into contact with the seawater can include directing the flue gas into countercurrent flow with the seawater in the rotating packed bed. Directing the flue gas in the rotating packed bed into contact with the seawater in the rotating packed bed can include transferring at least a portion of sulfur dioxide and nitrogen dioxide in the flue gas to the seawater. Directing the flue gas into contact with the oxidizing agent in the first chamber of the contactor can include directing the flue gas into contact with a solution of sodium chlorite, hydrogen peroxide, or sodium hypochlorite residing in the first chamber to convert the at least a portion of nitrogen oxide in the flue gas into nitrogen dioxide. The method can further include increasing a pressure of the flue gas with a blower unit positioned between the marine engine and the contactor, and directing, with the blower unit, the flue gas toward the contactor. The method can further include filtering, with a filter positioned upstream of the contactor, particulate matter and volatile hydrocarbons from the flue gas. The method can further include directing the flue gas to a first rotating packed bed having an absorption agent, and absorbing, with the absorption agent in the first rotating packed bed, at least a portion of the carbon dioxide from the flue gas. The method can further include directing the absorption agent with the absorbed carbon dioxide to a second rotating packed bed, and desorbing, in the second rotating packed bed, the absorbed carbon dioxide from the absorption agent. The method can further include directing the desorbed carbon dioxide to a storage system, compressing, with a compressor of the storage system, the carbon dioxide, and storing, with a storage tank of the storage system, the compressed carbon dioxide. The method can further include directing the flue gas from the first rotating packed bed to a water wash station including a housing enclosing a wash chamber, and washing, in the wash chamber of the water wash station, the flue gas with water.

Some aspects of the disclosure describe a gas conditioning system for removing contaminants including carbon dioxide from flue gas. The gas conditioning system includes a rotating packed bed assembly fluidly connected to an exhaust port of an engine, where the rotating packed bed assembly receives a flue gas from the exhaust port. The rotating packed bed assembly includes a first rotating packed bed having an absorption agent to absorb a portion of the carbon dioxide from the flue gas, and a second rotating packed bed to receive the absorption agent from the first rotating packed bed and desorb at least some of the portion of the carbon dioxide from the absorption agent.

These aspects, and other aspects, can include one or more of the following features. The absorption agent can include a liquid solvent. The liquid solvent can include an amine solvent. The rotating packed bed assembly can further include a water wash station fluidly connected to the first rotating packed bed, where the water wash station washes the flue gas from the first rotating packed bed with water. The water wash station can include a packed cylinder or a rotating packed bed. The rotating packed bed assembly can further include a third rotating packed bed in series with the first rotating packed bed, where the third rotating packed bed includes a second portion of the absorption agent, and the third rotating packed bed absorbs a second portion of the carbon dioxide from the flue gas. The rotating packed bed assembly can further include an intercooler fluidly coupled to the first rotating packed bed and the third rotating packed bed, where the intercooler cools the second portion of the absorption agent and directs the second portion of the absorption agent to the first rotating packed bed. The rotating packed bed assembly can further include an intercooler fluidly coupled to the first rotating packed bed and the third rotating packed bed, where the intercooler cools the first portion of the absorption agent and directs the first portion of the absorption agent to the third rotating packed bed. The rotating packed bed assembly can further include a third rotating packed bed in parallel with the first rotating packed bed, where the first rotating packed bed receives a first portion of the flue gas and the third rotating packed bed receives a second portion of the flue gas, and the third rotating packed bed includes a second portion of the absorption agent. The rotating packed bed assembly can further include a fourth rotating packed bed in series with the second rotating packed bed, where the fourth rotating packed bed receives the absorption agent from the second rotating packed bed and desorbs at least some of the carbon dioxide from the absorption agent. The rotating packed bed assembly can further include an interheater fluidly coupled to the second rotating packed bed and the fourth rotating packed bed, where the interheater heats the absorption agent from the second rotating packed bed and directs the absorption agent to the fourth rotating packed bed. The rotating packed bed assembly can further include a fourth rotating packed bed in parallel with the second rotating packed bed, where the second rotating packed bed receives a first portion of the absorption agent and the fourth rotating packed bed receives a second portion of the absorption agent. The gas conditioning system can further include a storage system fluidly connected to the second rotating packed bed and including a compressor and a storage tank, where the storage system receives the desorbed carbon dioxide, compresses the desorbed carbon dioxide with the compressor, and stores the carbon dioxide in the storage tank. The gas conditioning system can further include a selective catalytic reduction unit positioned upstream of the rotating packed bed assembly fluidly between the exhaust port and the rotating packed bed assembly, where the selective catalytic reduction unit includes a fluid inlet fluidly connected to the exhaust port and a fluid outlet, and the selective catalytic reduction unit receives the flue gas from the exhaust port through the fluid inlet and converts at least a portion of nitrogen oxides in the flue gas into nitrogen gas. The selective catalytic reduction unit can receive the exhaust flue gas from the engine at a temperature between 150 degrees Celsius and 550 degrees Celsius and convert the portion of the nitrogen oxides in the flue gas to nitrogen gas at a temperature between 150 degrees Celsius and 350 degrees Celsius. The selective catalytic reduction unit can include a housing defining a chamber, and a compound inlet to introduce a mist of a compound solution into the chamber, where the fluid inlet directs the flue gas into contact with the mist of compound solution in the chamber. The compound solution can include urea or ammonia. The selective catalytic reduction unit can include a catalyst disposed in the chamber, where the catalyst contacts the flue gas and the mist of urea solution in the chamber. The gas conditioning system can further include an oxidizer unit having a fluid inlet fluidly connected to the exhaust flue gas from the engine and a fluid outlet fluidly connected to the rotating packed bed assembly, where the oxidizer unit receives the exhaust flue gas from the engine through the fluid inlet and converts at least a portion of the nitrogen oxides in the flue gas into nitrogen dioxide and at least a portion of the sulfur dioxide in the flue gas into sulfur dioxide. The gas conditioning system can further include a direct contact cooler positioned upstream of the rotating packed bed assembly and fluidly between the exhaust port and the rotating packed bed assembly, where the direct contact cooler includes a fluid inlet fluidly connected to the exhaust port, a housing enclosing a cooling chamber, and a fluid outlet, and where the direct contact cooler directs the flue gas into contact with seawater residing in the cooling chamber and cools the fluc gas to a temperature less than or equal to 60 degrees Celsius. The direct contact cooler can include a third rotating packed bed having the housing enclosing the cooling chamber, a rotor drum disposed within the housing and rotatable about a rotational axis, a seawater inlet fluidly connected to the rotor drum, a seawater outlet fluidly connected to the housing, the fluid inlet fluidly connected to the housing, and the fluid outlet fluidly connected to the rotor drum, where the flue gas is directed from the fluid inlet to the fluid outlet, and the seawater is directed from the seawater inlet to the seawater outlet. The flue gas can be disposed in countercurrent flow with the seawater within in the rotor drum when the third rotating packed bed is in use. The direct contact cooler can include a seawater inlet to direct the seawater into the cooling chamber, where the seawater removes at least a portion of sulfur dioxide and nitrogen dioxide from the flue gas in the cooling chamber. The gas conditioning system can further include an adsorption unit positioned upstream of the rotating packed bed assembly and fluidly between the exhaust port and the rotating packed bed assembly, where the adsorption unit includes a fluid inlet fluidly connected to the exhaust port and the adsorption unit receives the flue gas from the exhaust port and removes at least a portion of nitrogen oxides from the flue gas. The adsorption unit can include at least one adsorption bed, where the gas conditioning system directs the flue gas from the fluid inlet through the at least one adsorption bed, and the adsorption bed reduces a nitrogen oxide content from the flue gas to less than 10 parts per million.

Certain instances of the disclosure encompass a method for conditioning flue gas. The method includes directing a flue gas from an exhaust port to a rotating packed bed assembly, where the rotating packed bed assembly includes a first rotating packed bed and a second rotating packed bed, and absorbing, with an absorption agent in the first rotating packed bed, at least a portion of the carbon dioxide from the flue gas. The method also includes directing the absorption agent with the absorbed carbon dioxide from the first rotating packed bed to the second rotating packed bed, and desorbing, in the second rotating packed bed, the carbon dioxide from the absorption agent.

These aspects, and other aspects, can include one or more of the following features. The method can further include directing the desorbed carbon dioxide to a storage system, compressing the carbon dioxide with a compressor of the storage system, and storing the compressed carbon dioxide with a storage tank of the storage system. The method can further include directing the flue gas from the first rotating packed bed to a water wash station, and washing, in a wash chamber of the water wash station, the flue gas with water. The rotating packed bed assembly can further include a third rotating packed bed in series with the first rotating packed bed and including a second portion of the absorption agent, and the method can further include directing the flue gas from the first rotating packed bed to the third rotating packed bed, and absorbing, with the second portion of the absorption agent in the third rotating packed bed, a second portion of the carbon dioxide from the flue gas. The method can further include directing the second portion of the absorption agent from the third rotating packed bed to an intercooler fluidly coupled to the first rotating packed bed and the third rotating packed bed, cooling the second portion of the absorption agent with the intercooler, and directing the cooled second portion of the absorption agent to the first rotating packed bed. The method can further include directing the first portion of the absorption agent from the first rotating packed bed to an intercooler fluidly coupled to the first rotating packed bed and the third rotating packed bed, cooling the first portion of the absorption agent with the intercooler, and directing the cooled first portion of the absorption agent to the third rotating packed bed. The rotating packed bed assembly can further include a fourth rotating packed bed in series with the second rotating packed bed, and the method can further include directing the absorption agent from the second rotating packed bed to the fourth rotating packed bed, and desorbing at least some of the carbon dioxide from the absorption agent in the fourth rotating packed bed. Directing the absorption agent from the second rotating packed bed to the fourth rotating packed bed can include directing the absorption agent from the second rotating packed bed to an interheater fluidly coupled to the second rotating packed bed and the fourth rotating packed bed, heating the absorption agent with the interheater, and directing the heated absorption agent to the fourth rotating packed bed. The method can further include receiving, at a chamber of an oxidizer unit disposed fluidly between the exhaust port and the rotating packed bed assembly, the flue gas from the exhaust port at a temperature between 150 degrees Celsius and 550 degrees Celsius, and converting, with a reactant in the chamber of the oxidizer unit, a portion of the nitrogen oxides in the flue gas into at least one of nitrogen gas or nitrogen dioxide at a temperature between 150 degrees Celsius and 550 degrees Celsius. The reactant can include an oxidizing agent, and converting, with the reactant in the chamber of the oxidizer unit, can further include converting a portion of the sulfur oxides in the flue gas into sulfur dioxide with the oxidizing agent. The oxidizer unit can include a selective catalytic reduction unit, and the converting can include converting the portion of the nitrogen oxides in the flue gas into nitrogen gas at the temperature between 150 degrees Celsius and 550 degrees Celsius. The reactant can include a catalyst, and converting the portion of the nitrogen oxides in the flue gas into nitrogen gas can include directing the flue gas into contact with a mist of compound solution in the chamber and further directing the flue gas and the mist of compound solution toward the catalyst in the chamber. The compound solution can include a urea solution or an ammonia solution. The method can further include receiving, at a direct contact cooler disposed fluidly between the exhaust port and the rotating packed bed assembly, the flue gas from the exhaust port, and cooling, with direct contact of the flue gas with seawater in the direct contact cooler, the flue gas to a temperature less than or equal to 60 degrees Celsius. The method can further include receiving, at an adsorption unit, the flue gas from the direct contact cooler, and removing, at the adsorption unit, at least a portion of remaining nitrogen oxides from the cooled flue gas. Removing at least a portion of remaining nitrogen oxides from the cooled flue gas can include directing the cooled flue gas through at least one adsorption bed of the adsorption unit to reduce a nitrogen oxide content of the flue gas to less than 50 parts per million.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic block flow diagram of an example conditioning system for conditioning flue gas from a marine vessel engine.

FIG. 2 is an example schematic perspective view of an example rotating packed bed system that can be used in the example conditioning system of FIG. 1.

FIG. 3 is a perspective view of an example marine vessel including a gas conditioning system mounted on the example marine vessel.

FIG. 4 is a flowchart describing an example method for conditioning a flue gas from a marine vessel.

FIG. 5 is a flowchart describing another example method for conditioning a flue gas.

FIG. 6 is a flowchart describing another example method for conditioning a flue gas from a marine vessel.

FIG. 7 is a flowchart describing another example method for conditioning a glue gas.

Like reference symbols in the various drawings indicate like elements.

### DETAILED DESCRIPTION

This disclosure describes gas conditioning systems for treatment and conditioning of flue gas, such as flue gas from an engine of a marine vessel, to remove or reduce pollutant emissions from the flue gas. Pollutants can include carbon dioxide (CO₂), nitrogen oxides (i.e., NOₓ, including nitrogen dioxide (NO₂), nitrogen oxide (NO), dinitrogen oxide (N₂O), or a combination of N₂O, NO₂, and/or NO), sulfur oxides (i.e., SOₓ, including sulfur dioxide (SO₂), sulfur oxide (SO), or both SO₂ and SO), particulate matter, volatile hydrocarbons, a combination of these, or other polluting materials. Marine vessels can include container ships, tanker vessels, vehicle transport ships, cruise liners, or other marine vessels that include one or more marine engines. In some instances, a gas conditioning system can be retrofitted onto an existing marine vessel and positioned to intercept a flow of flue gas between an exhaust outlet of the marine vessel engine and an exhaust stack outlet of the marine vessel.

Pollutants from flue gas from a marine diesel engine can include higher concentrations of sulfur oxides, nitrogen oxides, or both, as compared to sulfur oxide and nitrogen oxide concentrations of other land-based engine systems. Solvents used for separating pollutants from a gas flow can vary based on the type of pollutant desired to be separated. In some implementations, a gas conditioning system preconditions a flue gas to remove all or a portion of the sulfur oxides, nitrogen oxides, or both sulfur oxides and nitrogen oxides, prior to removal of all or a portion of CO₂ from the gas. For example, sulfur oxides and/or nitrogen oxides can overwhelm, degrade, or otherwise negatively affect solvents used for CO₂ removal from flue gas such that CO₂ removal is insufficient or incomplete. Pretreatment of flue gas removes or reduces the sulfur oxides and/or nitrogen oxides prior to CO₂ treatment to produce a more efficient removal of pollutants from a flue gas while efficiently utilizing solvent(s). In certain implementations of preconditioning a flue gas with a gas conditioning system, seawater can be utilized to contact and cool the flue gas, to remove all or a portion of the NOₓ and SOₓ from the flue gas, or both, and the seawater can be recycled and/or pass through an effluent system (i.e., water treatment system) to treat the seawater prior to recycling.

Marine vessels operate under US and/or international regulations for emissions controls, such as the International Maritime Organization IMO 2020 under MARPOL Annex VI. Under these emission regulations, pollutants in flue gas must fall under certain threshold maximums for CO₂ and other pollutants. Some of these regulations have driven industry to pursue cleaner, more expensive fuels due to a smaller concentration of pollutants in its flue gas. However, a gas conditioning system of the present disclosure can be implemented on marine vessels to better condition flue gas from marine engines and remove a larger concentration and larger number of pollutants from the flue gas, even when treating flue gas from an engine consuming fuel with a higher concentration of sulfur.

In certain land-based flue gas treatment systems, packed columns are utilized for treatment of carbon emissions from flue gas. However, packed columns require a large spatial footprint, and may not adequately operate when on a moving platform (e.g., not on a static, land-mounted platform). In gas conditioning systems of the present disclosure, such as a gas conditioning system on a marine vessel, the use of large footprint devices (such as packed columns) is reduced or avoided to efficiently maximize a limited space while maintaining sufficient operating performance. For example, a gas conditioning system can include one or more rotating packed beds (RPBs) in various stages of a conditioning operation, such as during direct contact cooling, CO₂ absorption, CO₂ desorption, water washing, or other operational stages that, in land based systems, would typically be performed by larger footprint devices, such as packed columns. Packed columns on a moving platform, such as a platform on an operating marine vessel, may have diminished performance due to solvent maldistribution caused by the moving vessel. The impact of motion on liquid/gas distribution in columns affects column performance for at least two reasons. A first reason is the static tilt of the column from verticality. Amplitude in oscillations and/or the period of oscillations (e.g., tilt) can divert liquid in the column from its axial route normally expected in onshore absorber columns or regenerator columns. The distortion created by non-verticality generates accumulation of liquid in some places, and drought in other places of the column section, which can cause slippage of untreated gas. A second reason is the forces of acceleration generated by the movement of the hull of a marine vessel, amplified in some places by a large distance between upper beds of the column and the center of rotation in the column. Radial forces imposed by accelerations can cause the liquid to deviate from even distribution in the column. This maldistribution affects the contact between liquid and gas phases and can reduce the effective area for mass transfer between phases. A gas conditioning system of the present disclosure provides benefits including a reduced spatial footprint, the capability of treating a variety of pollutants from flue gas (i.e., nitrogen oxides, sulfur oxides, CO₂, and/or other pollutants), conditioning operations that can be performed on a moving platform (such as a moving marine vessel), increased pollutant capture capability, increased operational flexibility (such as high downturn capability), and/or reduction in the consumption of energy required to implement the capture of pollutants from a flow of flue gas.

The present disclosure describes gas conditioning systems for use on marine vessels and for conditioning flue gas from marine engines of marine vessels. However, the gas conditioning systems described herein can be utilized for other engine systems for treatment of other types of flue gas, such as in land-based engine systems. For example, a gas conditioning system described herein can connect to an exhaust system of a marine diesel engine on a marine vessel, to an exhaust system of a land-based hydrocarbon combustion source such as a furnace in a production facility, refinery, cement plant, steel mill or factory, mobile land-based generators, a combination of these, or other combustion gas sources.

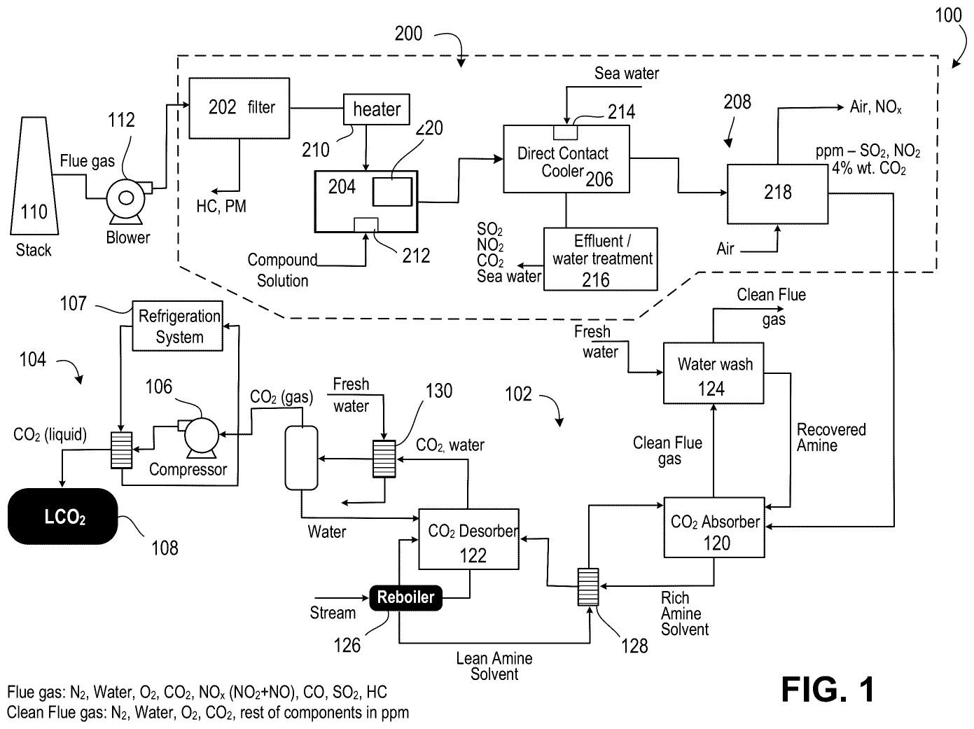

FIG. 1 is a schematic block flow diagram of an example gas conditioning system 100 for conditioning flue gas from an engine, such as a marine diesel engine of a marine vessel. The example conditioning system 100 can be implemented on a marine vessel, though the example conditioning system 100 can instead be implemented with different engine systems separate from a marine vessel. The example gas conditioning system 100 receives a flow of flue gas from the engine, removes pollutants from the flue gas, and releases the conditioned flue gas after removal or reduction of the pollutants. The example gas conditioning system 100 includes a carbon dioxide capture system 102 for separating carbon dioxide from the flue gas flowing through the carbon dioxide capture system 102, a preconditioning system 200 for pretreatment of the flue gas prior to flowing to the carbon dioxide system 102, and a storage system 104 for storing the carbon dioxide separated from the flue gas in the carbon dioxide system 102.

In operation of the example gas conditioning system 100, flue gas from the engine flows through the preconditioning system 200 for reduction or removal of certain pollutants from the flue gas, such as nitrogen oxides and sulfur oxides. For example, flue gas from an exhaust stack 110 of the engine is directed to the preconditioning system 200. In some examples, a blower 112 directs the flue gas from the exhaust stack 110 (or other exhaust component from the engine) to the preconditioning system 200. The blower 112 increases or maintains a pressure of the flue gas to overcome any eventual pressure drops of the flue gas as it flows through the preconditioning system 200 and/or carbon dioxide capture system 102, and prevents a backpressure on the engine of the marine vessel. The blower 112 is shown in FIG. 1 as between the exhaust stack 110 and the preconditioning system 200, though the location of the blower 112 can vary. For example, the blower 112 can be positioned within the preconditioning system 200 itself, such as between components or downstream after components of the preconditioning system 200. In some implementations, the blower 112 is positioned downstream of the direct contact cooler (described later) of the preconditioning system 200, for example, to generate a partial vacuum in the flow of exhaust gas through the components of the preconditioning system 200 upstream of the blower 112. The partial vacuum provides for draft flow of the exhaust gas through the upstream components (i.e., between the exhaust stack 110 and the blower 112) and toward the blower 112. At the blower 112, the pressure of the exhaust gas is increased in preparation for flowing to downstream components, such as the carbon dioxide capture system 102. The blower 112 or additional blowers can be positioned in other locations along the flow of exhaust gas to generate a partial vacuum in the exhaust gas flow, increase a pressure of the exhaust gas, or both.

In the preconditioning system 200, once the nitrogen oxides and/or sulfur oxides are removed from the flue gas, or concentration of the nitrogen oxides and sulfur oxides reduced below maximum threshold concentrations in the flue gas, the resultant flue gas flows to the carbon dioxide capture system 102, where the carbon dioxide in the flue gas is removed from the flue gas or the concentration of carbon dioxide is reduced to below acceptable thresholds. The resultant, clean flue gas from the carbon dioxide capture system 102 is released, such as to the atmosphere, and the removed carbon dioxide is directed to the storage system 104. The storage system 104 receives and stores the carbon dioxide, for example, during a voyage of the marine vessel.

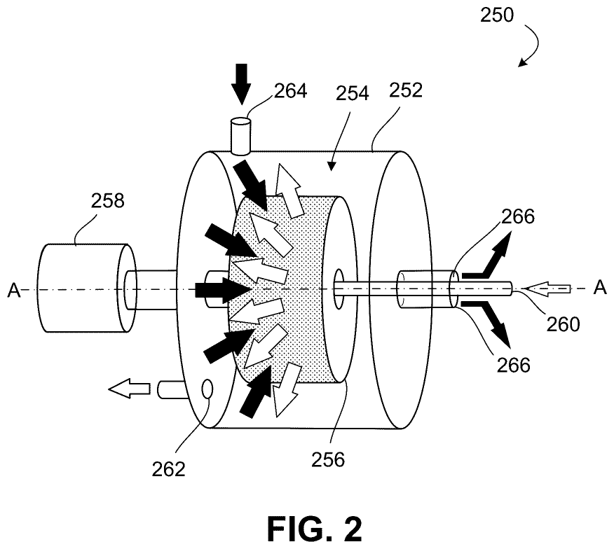

In the example gas conditioning system 100, the carbon dioxide capture system 102 receives flue gas from the preconditioning system 200, and removes all or a portion of the carbon dioxide from the flue gas. In some instances, the flow of flue gas can bypass the preconditioning system 200, and flow directly from the blower 112, engine exhaust outlet, or other engine exhaust component to the carbon dioxide capture system 102. The carbon dioxide capture system 102 includes a rotating packed bed assembly that fluidly connects to an exhaust port of the engine and receives the flue gas. An example RPB system is shown in FIG. 2, and is described later. The rotating packed bed assembly includes a first rotating packed bed 120, referred to as an RPB absorber 120, which includes an absorption agent for absorbing a portion of the carbon dioxide from the flue gas. The absorption agent is a substance used to capture a pollutant (such as carbon dioxide) from a fluid stream (e.g., flow of flue gas) by chemisorption (such as an amine solution, sodium hydroxide, aqueous ammonia, carbonic anhydrase, a combination of these, and/or other substances), by physical absorption (such as methanol, glycols, dymethyl ether, a combination of these, or other substances), or a mix of chemisorption substances or physical absorption substances. The absorption agent can vary, for example, based on the type of pollutant desired to be absorbed or adsorbed from the flue gas. In some examples, the absorption agent includes a solvent, such as a liquid solvent and/or chemical solvent, for absorption of carbon dioxide (or other pollutant). For example, a liquid solvent can include an amine solvent, amino acids, sodium hydroxide (NaOH), potassium hydroxide (KOH), potassium carbonate (K₂CO₃), ionic liquids, inorganic solvents a combination of these, or other solvents. In the example gas conditioning system 100 of FIG. 1, the absorption agent includes an amine solvent; however, other absorption agents can be used to absorb carbon dioxide and/or other pollutants from the flue gas.

The rotating packed bed assembly also includes a second rotating packed bed 122, referred to as an RPB desorber, which receives the absorption agent from the first rotating packed bed 120 and desorbs at least some of the carbon dioxide from the absorption agent.

The RPB absorber 120 absorbs carbon dioxide from the flue gas, and binds the carbon dioxide to the absorption agent. For example, flue gas enters the RPB absorber 120 and contacts the absorption agent, where CO₂ enters the liquid phase and reacts with the absorption agent. After absorption, the treated flue gas can leave the RPB absorber 120 and can be released to the atmosphere. In some implementations, such as in the example gas conditioning system 100 of FIG. 1, the rotating packed bed assembly of the carbon dioxide capture system 102 also includes a water wash station 124 fluidly connected to the first rotating packed bed 120. The water wash station 124 washes the flue gas from the first rotating packed bed 120 with water, for example, to remove any residual, volatile absorption agent that may leave the RPB absorber 120 with the cleaned flue gas. The water wash station 124 can take a variety of forms, such as a packed cylinder or a rotating packed bed, where the water in the water wash station 124 contacts the flue gas from the RPB absorber 120. The water with the captured absorption agent can be returned to the RPB absorber 120, for example, to be recombined with the absorption agent for reuse or recycling of the absorption agent.

In some implementations, the RPB absorber 120 can include multiple RPBs, positioned in series, in parallel, or a combination of parallel RPBs and series RPBs. In an example system, the RPB absorber 120 includes two RPBs in series, forming a first RPB absorber and a second RPB absorber, where the flue gas moves through the first RPB absorber and second RPB absorber in series. The first RPB absorber can include a first portion of the absorption agent for absorbing a first portion of the carbon dioxide in the flue gas, and the second RPB absorber can include a second portion of the absorption agent to absorb a second portion of the carbon dioxide in the flue gas. One or both of the first RPB absorber or second RPB absorber can fluidly connect to the water wash station 124 for washing the flue gas. In examples with multiple RPB absorbers, the water wash station 124 can connect to the last RPB absorber (e.g., farthest downstream absorber RPB) of the example RPB assembly. In certain implementations, the rotating packed bed assembly also includes an intercooler fluidly coupled between RPB absorbers. The intercooler can be used to cool the absorption agent, such as the first portion or the second portion of the absorption agent, and direct the cooled absorption agent to the first RPB absorber or second RPB absorber. In certain instances where the RPB absorber 120 includes multiple RPBs, an intercooler can be positioned between one or more or all pairs of series RPBs of the multiple RPBs. Temperature bulges in the flue gas/liquid agent can occur due to higher heat of absorption and lower heat capacities, which shifts the equilibrium in a chamber. One or more intercoolers can control the temperature bulges, for example, to approach isothermal conditions. The effectiveness of intercooling depends at least partially on the nature of the absorption agent, such as the heat of absorption and physical properties, and the ratio between gas and liquid flowrates through the RPB(s).

The number and arrangement of RPBs of the RPB absorber 120 can vary, for example, to include multiple RPBs in series, multiple RPBs in parallel, or an arrangement of RPBs including in-series RPBs and in-parallel RPBs. For example, parallel RPBs can be utilized to treat a larger volume of flue gas at one time, and series RPBs can be utilized to better cool the absorption agent, promote a more complete saturation of an absorption agent, more effectively and efficiently capture pollutants, decrease an amount of absorption agent used, or a combination of these. The arrangement of RPBs of the RPB absorber 120 can include series RPBs, parallel RPBs, or a combination of these, to optimize flue gas conditioning. In some implementations, the RPB absorber 120 can include multiple RPBs including parallel and series arrangements, and a flow controller (not shown) can direct flue gas through one or more pathways along the arrangement in order to optimize a characteristic of the flue gas. For example, the flow controller can direct the flue gas into two (or more) parallel RPBs in instances of increased flue gas flow into the RPB absorber 120, and/or the flow controller can direct the flue gas into two (or more) series RPBs in instances where a more complete absorption of a pollutant by the absorption agent is desired.

In the RPB desorber 122, the rich absorption agent received from the RPB absorber 120 flows through the RPB desorber 122 and comes into contact with vapor from a reboiler 126. The rich absorption agent is heated to break the bond between CO₂ and the absorption agent, and contact with the vapor strips the CO₂ from the absorption agent. In some instances, after stripping the CO₂ from the absorption agent, the absorption agent can be returned to the RPB absorber 120 for reuse, or recycled in another way. The captured CO₂ from the RPB desorber 122 can be directed to the storage system 104, described later.

In some implementations, the RPB desorber 122 can include multiple RPBs, positioned in series, in parallel, or a combination of parallel RPBs and series RPBs. In an example system, the RPB desorber 122 includes two RPBs in series, forming a first RPB desorber and a second RPB desorber, where the absorption agent moves through the first RPB desorber and second RPB desorber in series. The first RPB desorber can strip (or desorb) a first portion of CO₂ from the absorption agent, and the following second RPB desorber can strip a second portion of CO₂ from the absorption agent. In certain implementations, the rotating packed bed assembly also includes an interheater fluidly coupled to the first RPB desorber and the second RPB desorber, such as between RPB desorbers. The interheater can be used to heat the absorption agent as it moves from the first RPB desorber to the second RPB desorber. In certain instances where the RPB desorber 122 includes multiple RPBs, an interheater can be positioned between one or more or all pairs of series RPBs of the multiple RPBs.

The number and arrangement of RPBs of the RPB desorber 122 can vary, for example, to include multiple RPBs in series, multiple RPBs in parallel, or an arrangement of RPBs including in-series RPBs and in-parallel RPBs. For example, parallel RPBs can be utilized to treat a larger volume of rich absorption agent at one time, and series RPBs can be utilized to increase a heating of the absorption agent, promote a more complete regeneration of the absorption agent, more effectively and efficiently desorb pollutants from the absorption agent, decrease an amount of steam needed at the reboiler 126, or a combination of these. The arrangement of RPBs of the RPB desorber 122 can include series RPBs, parallel RPBs, or a combination of these, to optimize absorption agent desorption and conditioning. In some implementations, the RPB desorber 122 can include multiple RPBs including parallel and series arrangements, and a flow controller (not shown) can direct the absorption agent (e.g., liquid amine solvent or other liquid solvent) through one or more pathways along the arrangement in order to optimize a characteristic of the absorption agent. For example, the flow controller can direct the absorption agent into two (or more) parallel RPBs in instances of increased flow of absorption agent into the RPB desorber 122, and/or the flow controller can direct the absorption agent into two (or more) series RPBs in instances where a more complete desorption of a pollutant from the absorption agent is desired. In some implementations of the RPB system that incorporate one or more intercoolers and one or more interheaters, the properties of the absorption agent (e.g., liquid amine solvent) and its optimal configuration may assist in obtaining optimal ratios between partial pressures of water and CO₂, which can reduce an overall energy consumption during regeneration of the absorption agent.

The carbon dioxide capture system 102 of the example gas conditioning system 100 includes RPBs to initiate the interaction between two fluids, such as between the flue gas and an absorption agent in the case of the RPB absorber(s), or between an absorption agent and a vapor in the case of the RPB desorber(s). In certain implementations where the example gas conditioning system 100 is disposed on a marine vessel, the use of RPBs ensures fluid interaction and liquid distribution between the two fluids, even during movements of the marine vessel during a voyage. Conversely, columns rely on gravity driven movement for fluid interaction, and relying on gravity driven movement on a moving platform may result in liquid maldistribution caused by movements of the moving platform (e.g., marine vessel movements). Instead, RPBs operate with little to no performance reduction based on absorption agent maldistribution caused by platform movements, while also reducing the overall footprint required for fluid interaction units, such as compared to columns.

In some implementations, the carbon dioxide capture system 102 of the example gas conditioning system 100 can include additional components to optimize a flow rate, flow capacity, flow composition, temperature, pressure, or other characteristics of the flue gas, absorption agent, and/or captured pollutant (e.g., carbon dioxide). For example, the carbon dioxide capture system 102 includes a first exchanger 128 positioned between the RPB absorber 120 and the RPB desorber 122 and a second exchanger 130 positioned between the RPB desorber 122 and the storage system 104. The first exchanger 128 is a heat exchanger that transfers heat between the rich absorption agent (e.g., rich amine solvent) flowing from the RPB absorber 120 to the RPB desorber 122 and the lean absorption agent (e.g., lean amine solvent) flowing from the RPB desorber 122 to the RPB absorber 120. In some instances, the first exchanger 128 transfers heat from the lean absorption agent to the rich absorption agent in order to reduce a temperature of the lean amine solvent and increase a temperature of the rich amine solvent. The first heat exchanger 128 can include a plate and frame heat exchanger or other type of cross exchanger. The second exchanger 130 is a cross-exchanger, gas-liquid separator, or both, that receives the water and carbon dioxide mixture from the RPB desorber 122 and separates the carbon dioxide from the water. The second exchanger 130 separates the carbon dioxide from the water-CO₂ mixture from the RPB desorber 122, for example, to drop the water from the mixture before directing the CO₂ to the storage system 104. In some instances, the second exchanger 130 includes flash separator drum that receives a flow of water and the flow of the carbon dioxide and water mixture from the RPB desorber 122, and outputs a flow of water and a separate flow of the separated carbon dioxide. The separated flow of the carbon dioxide flows to the storage system 104, and the flow of water from the second exchanger 130 can be dispelled or recycled in systems within or external to the example gas conditioning system 100.

The storage system 104 of the example gas conditioning system 100 is fluidly connected to a downstream unit (e.g., the second rotating packed bed 122) of the carbon dioxide capture system 102, and receives the captured CO₂, and in some instances, evaporated water and traces of impurities with the captured CO₂. The storage system 104 cools the CO₂ to remove any water, compresses the CO₂, and further cools the CO₂ to liquefy the CO₂ for storage. The storage system 104 includes a compressor 106, a refrigeration system 107, and a storage tank 108. The refrigeration system 107 cools the captured CO₂, the compressor 106 compresses the captured CO₂, such as to a pressure of 320 pounds per square inch absolute (psia) or greater, and the storage tank 108 stores the CO₂ once it reaches its liquid phase. The storage system 104 can operate to store the captured CO₂ at a range of temperatures and pressures. For example, the storage system 104 can store the captured CO₂ within a temperature range between −56.6° C. (−69.88° F.) and 31° C. (87.8° F.), and/or within a pressure range between 5.2 bar and less than 74 bar (75.42 to 1073.28 psia).

The preconditioning system 200 of the example gas conditioning system 100 is positioned upstream of the carbon dioxide capture system 102 along the flow of flue gas from the engine, and preconditions the flue gas before the gas flows to the carbon dioxide capture system 102. The preconditioning system 200 conditions the flue gas to remove some or all sulfur oxides, some or all nitrogen oxides, particulates, volatile hydrocarbons, a combination of these, or other pollutants from the flue gas. In some instances, removal of the nitrogen oxides and sulfur oxides from the flue gas prior to the carbon dioxide capture system 102 allows the absorption agent of the carbon dioxide capture system 102 to more effectively remove CO₂ from the flue gas. Otherwise, the presence of nitrogen oxides, sulfur oxides, or both, in the flue gas would negatively affect the performance of the absorption agents and reduce the life of the absorption agents in the carbon dioxide capture system 102. The preconditioning system 200 of the example gas conditioning system 100 includes a filter 202, an oxidizer 204, a direct contact cooler 206, and a polisher 208. The filter 202, oxidizer 204, direct contact cooler 206, and polisher 208 are shown in series with each other, such that the flue gas flows through the filter 202, then the oxidizer 204, then the direct contact cooler 206, then the polisher 208. However, the order of these devices can be different, and one or more of these devices can be excluded altogether from the preconditioning system 200. For example, the preconditioning system 200 can exclude the filter 202, oxidizer 204, direct contact cooler 206, polisher 208, or a combination of these components. In certain examples, the preconditioning system 200 includes flow control devices (e.g., fluid valves) and flow pathways to direct flue gas through the preconditioning system 200 along a desired flowpath. The flow control devices and/or flow pathways can direct the flue gas through one or more or all components of the preconditioning system 200, and can be operated such that flue gas can bypass one or more or all of the components of the preconditioning system 200 between the engine and the carbon dioxide capture system 102.

The filter 202 removes or reduces particulate matter, volatile hydrocarbons, or both, from the flue gas. The filter 202 can include a housing with a filter media. The filter is positioned upstream of the oxidizer 204 and direct contact cooler 206, and filters the flue gas prior to flowing to the oxidizer 204 and/or direct contact cooler 206. In some implementations, the filter 202 can couple to, mount onto, or be integrated with the oxidizer 204, such as be positioned within a fluid inlet of the oxidizer 204 where flue gas is directed into the oxidizer 204.

The oxidizer 204, direct contact cooler 206, polisher 208, or a combination of these features, may include a packed bed, a packed cylinder, or a combination of these structures, for directing the flue gas into contact with a material. A packed bed is a vessel that can be filled (partially or completely) with material intended to contact and/or interact with a fluid flowing through the packed bed. The material can form a supporting structure, and can be coated with a catalyst. The catalyst can vary, and can be selective to the reduction of NOₓ, SOₓ, or other pollutant. The packed bed can have a varying height and form. A packed cylinder is a vessel that is filled (partially or completely) with a packing material that is positioned within an interior space of the vessel and is porous. The porosity, shape, and/or positioning of the packing material provides an effective area of contact between fluids, such as between liquid and vapor phases. The packing material can include one or multiple packing material units positioned within the vessel as a cartridge structure to increase an effective mass transfer between contacting fluids and reduce a pressure drop of fluid flowing through the packed cylinder. In some implementations, packed cylinders are smaller in size than packed columns, and can operate with a forced flow of fluid through the cylinder (i.e., packed cylinders are not gravity-driven in the way that packed columns operate, as described earlier).

The oxidizer 204 is a vessel or apparatus that directs contact of an inlet fluid with a reactant to prompt a chemical reaction in the inlet fluid. The reactant can include an oxidizing agent, such as oxygen, ozone, hydrogen peroxide, sodium hypochlorite, sodium chlorite (NaClO₂), or other oxidizing agents. The oxidizer 204 can include a packed bed or packed cartridge for directing contact of the inlet fluid with the oxidizing agent. Contact of the inlet fluid with the oxidizing agent promotes conversion of one or more components of the inlet fluid into a water-soluble species. In the example preconditioning system 200 of FIG. 1, the oxidizer 204 directs flue gas into contact with an oxidizer, for example, to convert some or all NO of the flue gas into the more water-soluble species of NO₂. The oxidizer 204 includes a fluid inlet and a fluid outlet, and an oxidizer housing that defines an oxidizing chamber. The oxidizer 204 receives the exhaust flue gas through the fluid inlet, oxidizes all or a portion of the flue gas within the oxidizing chamber, and directs the flue gas out of the fluid outlet. The oxidizer 204 converts all or a portion of the nitrogen oxides (NO) present in the flue gas residing in the oxidizer 204 (e.g., within the oxidizing chamber) into one or both of nitrogen gas (N₂) or nitrogen dioxide (NO₂). In some implementations, the oxidizer 204 also converts all or a portion of the sulfur oxides (SO) present in the flue gas in the oxidizer 204 into sulfur dioxide (SO₂). N₂, NO₂, and SO₂ are more easily separated from the flue gas than NO and SO, as described in greater detail later.

The oxidizer 204 can support the oxidizing agent as a solid, liquid, or gas, and supports the oxidizing agent in the chamber to contact the flue gas flowing through the chamber. In some instances, the oxidizing agent is in liquid form, such as a solution of the oxidizing agent, which is introduced to the flue gas in cross-flow, counterflow, or concurrent flow with the flue gas. In some implementations, the oxidizer 204 includes a contactor 220 integrated with the oxidizer 204, such as within the chamber of the oxidizer 204. The contactor 220 introduces sodium chlorite or other oxidizing agent to the flue gas flowing through the contactor 220. In some instances, the oxidizing agent is sodium chlorite that is introduced in the contactor as a solution of NaClO₂ that comes into direct contact with the flue gas, such as in counterflow or cross-flow with the flue gas. The contactor 220 includes a housing defining a chamber (e.g., a separate chamber or the same chamber of the oxidizer 204), and the sodium chlorite resides in the chamber or is introduced to the chamber in liquid form through one or more nozzles or other fluid pathway(s). Flue gas is introduced to the chamber to contact the sodium chlorite. The sodium chlorite, when in contact with the flue gas, oxidizes some or all of the nitrogen oxide (NO) in the flue gas into nitrogen dioxide (NO₂), thereby reducing the nitrogen oxide (NO) content. In some implementations, the direct contact cooler 206 receives the flue gas from the contactor 220, and the direct contact cooler 206 removes some or all of the nitrogen dioxide from the flue gas. In certain implementations, the adsorption unit 218 (described later) receives the flue gas flow from the direct contact cooler 206, and removes all or a portion of any remaining nitrogen oxides (NO, NO₂, or both) from the flue gas, prior to directing the flue gas flow to the carbon dioxide removal system 102.

The oxidizer 204 can receive the flue gas at a range of temperatures and still function to convert the nitrogen oxides and/or sulfur oxides in the flue gas to nitrogen dioxide and/or sulfur dioxide. For example, the oxidizer 204 can receive a flue gas at a temperature as low as 150 degrees Celsius (° C.), such as at or between 150° C. and 550° C., between 150° C. and 350° C., or between 150° C. and 310° C., and convert the NO and/or SO present in the flue gas at that temperature (e.g., between 150° C. and 550° C., 350° C., or 310° C.) to NO₂ and/or SO₂. In some implementations, the preconditioning system 200 includes a heater 210 upstream of the oxidizer unit 204, to heat the flue gas to a desired temperature. In certain instances, the flue gas can bypass the heater and flow directly to the oxidizer 204 without being heated by the heater 210.

In some examples, flue gas exits an engine at a temperature of around 250° C., and can go through a waste heat boiler that reduces the temperature of the flue gas, go through a heater (e.g., heater 210) or boiler to increase a temperature of the flue gas, or flow directly to the preconditioning system 200. In conventional combustion effluent treatment systems, a temperature of flue gas exiting an engine typically reaches temperatures around 350° C. or greater (such as in land-based engines), or is heated to temperatures around 350° C. or greater (such as in marine vessel-based engines). Heating a flue gas to a high temperature like 350° C. or greater may provide an easier oxidation of pollutants in the flue gas for an easier removal of the same pollutants. However, increasing the temperature of the flue gas can require additional energy and a separate heating unit. In the example gas conditioning system 100 of FIG. 1, the oxidizer 204 can receive the flue gas at temperatures lower than 350° C., such as between 150° C. and 310° C., and oxidize select pollutants from the flue gas without the additional energy consumption and/or heating unit typically required when heating a flue gas to 310° C. or greater (e.g., 350° C. or greater).

In some implementations, the oxidizer 204 includes a selective catalytic reduction (SCR) unit, where the reactant is a catalyst, and the SCR unit converts the portion of the nitrogen oxides (NOₓ) into nitrogen gas (N₂) using the catalyst. An SCR unit is a vessel or apparatus, such as a packed bed, that directs contact of an inlet fluid with a catalyst, where contact of the inlet fluid with the catalyst promotes conversion of one or more oxide gas components of the inlet fluid into a base version of the gas and water. For example, in the example preconditioning system 200 of FIG. 1, the SCR unit can direct the flue gas into contact with a catalyst to convert some or all NOₓ of the flue gas into nitrogen gas (N₂) and water (H₂O), using the catalyst to aid the reaction. The catalyst can vary. The SCR unit includes a chamber and a compound inlet 212 that introduces a solution of a compound to the chamber. The compound can vary. For example, the compound can include urea, ammonia, or other compounds that promotes conversion of nitrogen oxides to nitrogen gas. In some instances, the compound inlet 212 introduces the compound solution as a mist (e.g., a mist of urea, a mist of ammonia, or both), and the flue gas contacts the mist of compound solution. The SCR unit also includes a catalyst residing in the chamber to interact with the flue gas and compound mist mixture, and induces a chemical reaction that converts the nitrogen oxides into nitrogen gas. Equations 1 and 2, below, define the chemical reaction that occurs between the flue gas and a urea solution on the catalyst:

$$3 NO + {CO ( {NH}_{2} )}_{2} \to \frac{5}{2} {N}_{2} + 2 {H}_{2} O + {CO}_{2} \qquad Eq . 1$$

$$3 {NO}_{2} + 2 {CO ( {NH}_{2} )}_{2} \to \frac{7}{2} {N}_{2} + 4 {H}_{2} O + {CO}_{2} \qquad Eq . 2$$

Equations 3 and 4, below, define the chemical reaction that occurs between the flue gas and an ammonia solution on the catalyst:

$$4 NO + 4 {NH}_{3} + {O}_{2} \to 4 {N}_{2} + 6 {H}_{2} O \qquad Eq . 3$$

$$6 {NO}_{2} + 8 {NH}_{3} \to 7 {N}_{2} + 12 {H}_{2} O \qquad Eq . 4$$

Nitrogen gas is not considered a pollutant, and is effectively inert in the flue gas. Converting the nitrogen oxide (NOₓ) pollutants into nitrogen gas, water, and carbon dioxide effectively reduces the concentration of or removes the presence of nitrogen-based pollutants in the flue gas. The catalyst can vary. In some implementations, the catalyst includes a porous media, such as a honeycomb structure of material, disposed in the chamber to interact with flue gas and compound solution mixture. However, the catalyst can take other forms, shapes, and materials. For example, the catalyst can include a packed bed of porous media, and the catalyst material can include coated aluminum, ceramic material, or other materials. In some instances, the porous media provides a desired pressure drop of the fluid flowing through the catalyst.

The direct contact cooler 206 is a vessel or apparatus that directs an inlet fluid into direct contact with a cooler fluid, to cool the inlet fluid. The direct contact cooler 206 can include a packed bed or packed cartridge for directing contact of the inlet fluid with the relatively cooler fluid. The contact between the inlet fluid and the cooler fluid can be countercurrent flow, co-current flow, crossflow, or another relative flow orientation. The direct contact cooler 206 of the example gas conditioning system 100 includes a fluid inlet, a fluid outlet, and a cooling chamber defined by a housing of the direct contact cooler 206. The fluid inlet can connect to the fluid outlet of the oxidizer 204, to the filter 202, to the blower 112, or direct to an exhaust component of the engine, to receive the flow of flue gas. The direct contact cooler 206 directs the flue gas into contact with seawater residing in the cooling chamber, such as seawater entering through a seawater inlet 214, and cools the flue gas with the seawater to a desired temperature. The desired temperature can vary, such as a temperature of 60° C. or less, or 50° C. or less, for example, 40° C.

On a marine vessel, the direct contact cooler 206 has access to seawater in abundance, and the temperature of the seawater (e.g., 32° C. or less) is lower than the temperature of the flue gas into the direct contact cooler 206. The seawater, upon contact with the flue gas, cools the flue gas to a lower temperature, such as 60° C., 50° C., 40° C., or another temperature lower than 60° C. or 50° C. In addition to cooling the flue gas, the seawater can remove nitrogen dioxide, sulfur dioxide, or both nitrogen dioxide and sulfur dioxide from the flue gas within the cooling chamber. Seawater has a basic pH (e.g., a pH between 8.0 and 8.2), and in certain instances, the solubility of NO₂ and/or SO₂ in water allows seawater to remove the SO₂ and/or NO₂ from the flue gas without any other catalyst or solvent.

Removing the NO₂ and/or SO₂ from the flue gas with the seawater may decrease the pH of the seawater. In some implementations, the preconditioning system 200 includes a water treatment system 216 that receives the seawater used in the direct contact cooler 206 and treats the seawater to adjust its pH, turbidity, polyaromatic hydrocarbon (PAH) content, and/or nitrate content. The water treatment system 216 treats the seawater in order to allow for discharge of the used seawater overboard, while still complying with regulatory requirements for the disposal or recycling of seawater. The water treatment system 216 of the example gas conditioning system 100 includes a housing defining an inner chamber, a membrane (e.g., ceramic membrane) positioned within the inner chamber, and a dosification system (using NaOH or another buffer solution) to adjust the pH of the seawater to be above the acceptable limits for overboard disposal (e.g., pH greater than 6.5). In operation, seawater is introduced into the inner chamber and contacts the membrane, and the dosification system provides an adjusting solution to the inner chamber. The dosification system can include a dosing pump to provide a controlled amount of the adjusting solution to the effluent seawater. The water treatment system 216 can also include a temperature sensor to monitor the temperature of the seawater, for example, to ensure the seawater temperature remains below a maximum threshold temperature, such as a temperature of 60° C. established by IMO 2020.

In some implementations, the direct contact cooler 206 includes a rotating packed bed (RPB) to direct the flue gas into contact with the seawater. FIG. 2 is a schematic perspective view of an example rotating packed bed system 250 that can be used in the example gas conditioning system 100 of FIG. 1, such as in the direct contact cooler 206 for directing flue gas into countercurrent flow with seawater. The example RPB system 250 includes a housing 252 enclosing a chamber 254, and a rotor drum 256 disposed within the housing 252 and rotatable about a rotational axis A-A. In some implementations, the example RPB system 250 includes a motor 258 connected to (e.g., directly or indirectly coupled to) the rotor drum 256, such as by a drive shaft, to drive rotation of the rotor drum 256 about the rotational axis A-A. The rotor drum 256 defines radial flowpaths through the body of the rotor drum 256, between the radially exterior surface of the drum and the interior of the rotor drum 256. In some instances, the radial flowpaths include discrete radial channels through the body of the rotor drum that extend from an opening in the exterior surface of the rotor drum to an interior space of the rotor drum proximate to its radial center (i.e., near the rotational axis A-A). The radial flowpaths can define an array of pathways that fluidly connect the open space within the chamber 254 with the interior of the rotor drum 256. In certain implementations, the rotor drum 256 includes packing material within the rotor drum and can define the radial flowpaths through the rotor drum 256. The packing material can promote contact and mass transfer between a liquid and a gas flowing through the example RPB system 250.

The example RPB system 250 includes a fluid inlet 260 fluidly connected to an interior of the rotor drum 256, a fluid outlet 262 fluidly connected to the chamber 254 at an interior surface of the housing 252, a gas inlet 264 fluidly connected to the chamber 254 at an interior surface of the housing 252, and a gas outlet 266 fluidly connected to the interior of the rotor drum 256. In operation of the RPB system 250, a liquid flows through the liquid inlet 260 and into the interior of the rotor drum 256, and rotation of the rotor drum 256 directs the flow of liquid radially outward from the rotor drum 256 relative to the rotational axis A-A and through the radial flowpaths of the rotor drum 256. As the liquid flows out of the exterior surface of the rotor drum 256, the liquid subsequently flows toward the liquid outlet 262 at the interior wall of the housing 252. Conversely, a gas flows through the gas inlet 264 and into the chamber 254, into the radial flowpaths of the rotor drum 256 toward the interior of the rotor drum 256, and subsequently flows to the gas outlet 266. In the example RPB system 250 of FIG. 2, the gas and the liquid are disposed in counterflow with each other within the radial flowpaths of the rotor drum 256, in that the flow of liquid flows in an opposite direction to the flow of gas. For example, the liquid flows radially outward through the rotor drum 256 relative to the rotational axis A-A, and the gas flows radially inward through the rotor drum 256 relative to the rotational axis A-A, and the gas and the liquid contact each other in counterflow as they flow opposite to each other. In some implementations, the liquid flows radially outward through the rotor drum in response to a centrifugal force from rotation of the rotor drum 256, which provides a high surface area for mass transfer to occur between the gas and the liquid as the countercurrent gas contacts the liquid droplets toward the outer radial surface of the rotor drum 256.

In the example RPB system 250 of FIG. 2, the rotor drum 256 is oriented so that the rotational axis A-A is horizontal. However, this configuration and orientation can vary. For example, the rotor drum 256 can be oriented to rotate about an axis that is horizontal, vertical, or at an intermediate angle between vertical and horizontal.

Referring back to the direct contact cooler 206 of the example gas conditioning system 100 of FIG. 1, the direct contact cooler 206 can include an RPB, similar to the example RPB system 250 of FIG. 2. For example, the direct contact cooler 206 can include a housing enclosing a cooling chamber, a rotor drum disposed within the housing and rotatable about a rotational axis, a seawater inlet fluidly connected to the rotor drum, a seawater outlet fluidly connected to the housing, a second fluid inlet fluidly connected to the housing, and a second fluid outlet fluidly connected to the rotor drum. In an example operation, the flue gas is directed from the second fluid inlet to the second fluid outlet, seawater is directed from the seawater inlet to the seawater outlet, and the flue gas is disposed in countercurrent flow with the seawater within the rotor drum when the rotating packed bed is in use (e.g., the rotor drum is rotating). In operation, the seawater is directed into the cooling chamber, and the seawater can remove at least a portion of the sulfur dioxide, nitrogen dioxide, or both, from the flue gas in the cooling chamber. In some instances, the flue gas can be disposed in co-current flow with the seawater.

The polisher 208 is a vessel or apparatus that removes traces of pollutants from a fluid via reaction or adsorption using a porous media. The polisher 208 can include a packed bed or packed cartridge for directing contact of the fluid with a material. For example, the polisher 208 of the example preconditioning system 200 of FIG. 1 directs flue gas into contact with particles on a supporting structure in a cylinder of the polisher 208 to remove remaining traces of SOₓ and/or NOₓ from the flue gas before the flue gas enters the carbon dioxide capture system 102. The polisher 208 of the example preconditioning system 200 includes an adsorption unit 218 including packed cylinder, a fluid inlet fluidly connected to the fluid outlet of the direct contact cooler 206, and a fluid outlet. The adsorption unit 218 receives the flue gas from the direct contact cooler 206 and removes all or a portion of any remaining nitrogen oxides (e.g., NO, NO₂, or both) from the flue gas. In some implementations, the flow of flue gas bypasses the polisher 208, or the polisher 208 is removed altogether, such as when the flue gas has a concentration of nitrogen oxide (NO) that is below a maximum threshold concentration. For example, in instances where the oxidizer 204 converts all (entirely or substantially) of the nitrogen oxide (NO) in the flue gas to nitrogen dioxide (NO₂), and the direct contact cooler 206 then removes the nitrogen dioxide from the flue gas, the polisher 208 can be bypassed or excluded from the preconditioning system 200. However, in instances where the oxidizer 204 converts only some of the NO to NO₂, and a concentration of NO in the flue gas after the oxidizer 204 and direct contact cooler 206 is above the maximum threshold concentration, then the flow of flue gas is directed to the polisher 208 and the adsorption unit 218 can remove some or all of the remaining NO from the flue gas before it flows to the carbon dioxide removal system 102. In certain instances, such as when the oxidizer 204 includes an SCR unit that provides an incomplete conversion of the nitrogen oxides to nitrogen gas (i.e., some NOₓ remains in the flue gas), the polisher 208 can be utilized to remove some or all of the remaining NOₓ from the flue gas. However, when the SCR unit converts the nitrogen oxides in the flue gas to nitrogen gas, and a remainder of NOₓ in the flue gas is zero or otherwise below the maximum threshold concentration, the flue gas can bypass the polisher 208, or the polisher 208 can be excluded altogether from the preconditioning system 200.

The adsorption unit 218 can take a variety of forms. In some instances, the adsorption unit includes one or more adsorption beds (e.g., one adsorption bed, two adsorption beds, or more adsorption beds), where flue gas is directed through one or more of the adsorption beds. Each adsorption bed can reduce a nitrogen oxide content from the flue gas to below a threshold nitrogen concentration, such as 50 parts per million or less, 10 parts per million or less, or another concentration less than 50 parts per million. In examples where the adsorption unit includes two or more adsorption beds, one adsorption bed is used at a time, where a first adsorption bed is saturated with flue gas, and the other adsorption bed(s) regenerate, for example, by applying heat and a sweeping air stream to the other adsorption bed(s).

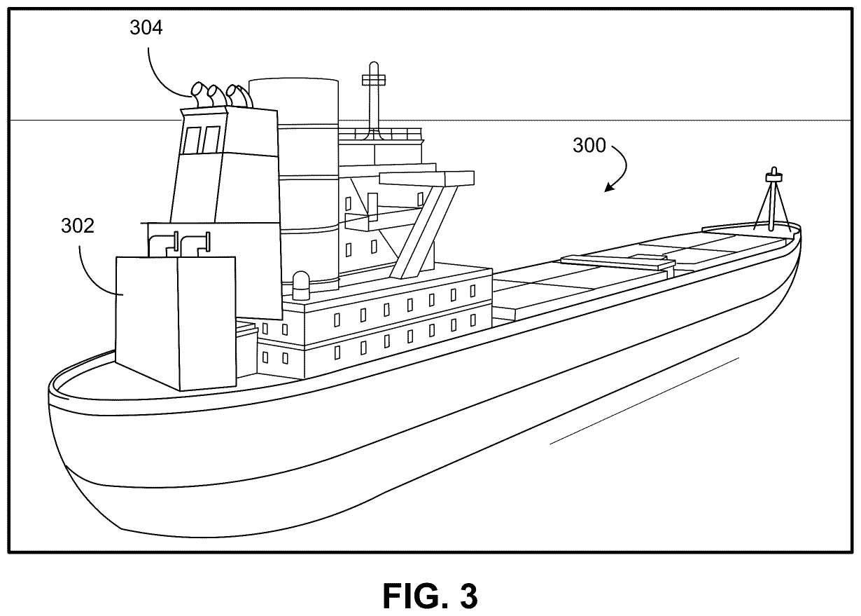

Some components or the entirety of the example gas conditioning system 100 can be housed in a single housing, such as within a container or housing type, for modular positioning of the gas conditioning system 100. The housing can be mounted on a marine vessel, positioned within a factory, or otherwise disposed proximate to an exhaust system of an engine and fluidly connected to the exhaust system, in order to treat a gas flowing through the example gas conditioning system 100. For example, FIG. 3 is a perspective view of an example marine vessel 300 including a gas conditioning system 302 mounted to a deck of the example marine vessel 300. The example marine vessel 300 includes a marine engine (not shown) and an exhaust system 304, where the gas conditioning system 302 is connected to the exhaust system 304 and intercepts flue gas through the exhaust system 304 to condition the flue gas, for example, to remove pollutants. The gas conditioning system 302 can be the same as the example gas conditioning system 100 of FIG. 1, but mounted within a container and onto the example marine vessel 300.

Although FIG. 3 depicts the example gas conditioning system 302 as mounted on a marine vessel, the gas conditioning system 302 can be utilized with different exhaust systems and/or in other technology spaces other than marine vessels.

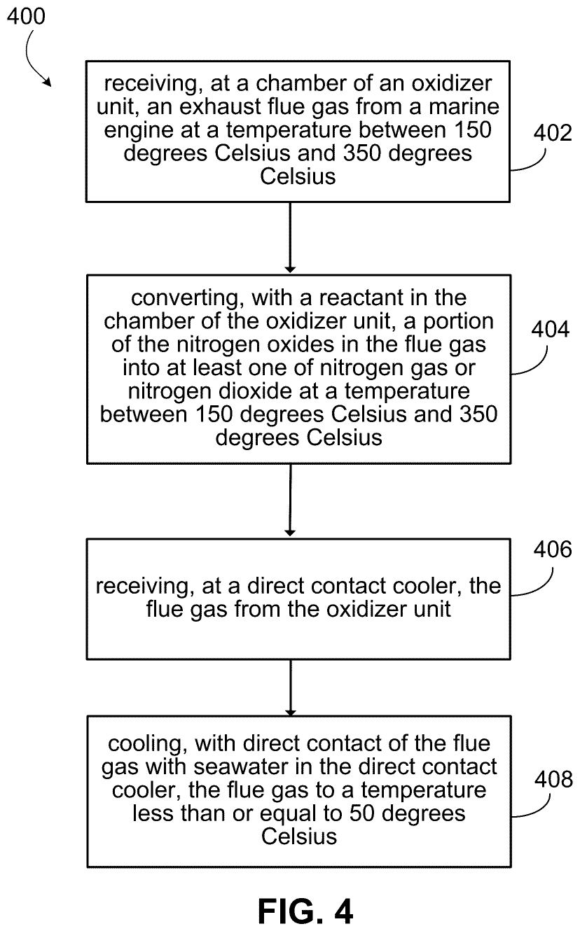

FIG. 4 is a flowchart describing an example method 400 for conditioning flue gas. The example method 400 can be performed by the example gas conditioning system 100 of FIG. 1, and can be used to condition flue gas from a marine vessel, such as the example marine vessel 300 of FIG. 3. At 402, an exhaust flue gas from a marine engine is received at a chamber of an oxidizer unit at a temperature between 150 degrees Celsius and 350 degrees Celsius. At 404, a portion of the nitrogen oxides in the flue gas is converted into at least one of nitrogen gas or nitrogen dioxide with a reactant in the chamber of the oxidizer unit at a temperature between 150 degrees Celsius and 350 degrees Celsius. At 406, the flue gas is received at a direct contact cooler from the oxidizer unit. At 408, the flue gas is cooled to a temperature less than or equal to 50 degrees Celsius with direct contact of the flue gas with seawater in the direct contact cooler.

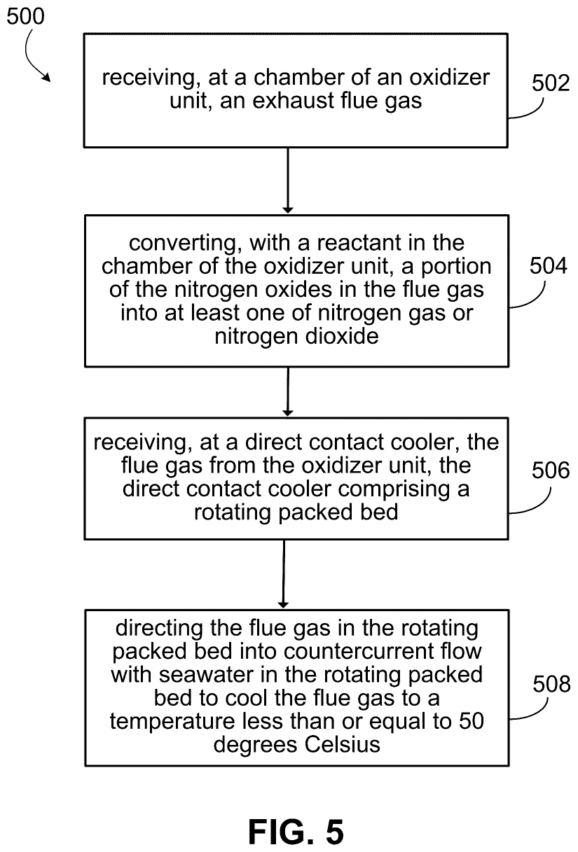

FIG. 5 is a flowchart describing another example method 500 for conditioning a flue gas. The example method 500 can be performed by the example gas conditioning system 100 of FIG. 1, and can be used to condition flue gas from a marine vessel, such as the example marine vessel 300 of FIG. 3. At 502, an exhaust flue gas is received at a chamber of an oxidizer unit. At 504, a portion of the nitrogen oxides in the flue gas are converted into at least one of nitrogen gas or nitrogen dioxide with a reactant in the chamber of the oxidizer unit. At 506, the flue gas from the oxidizer unit is received at a direct contact cooler. The direct contact cooler comprises a rotating packed bed. At 508, the flue gas in the rotating packed bed is directed into countercurrent flow with seawater in the rotating packed bed to cool the flue gas to a temperature less than or equal to 50 degrees Celsius.

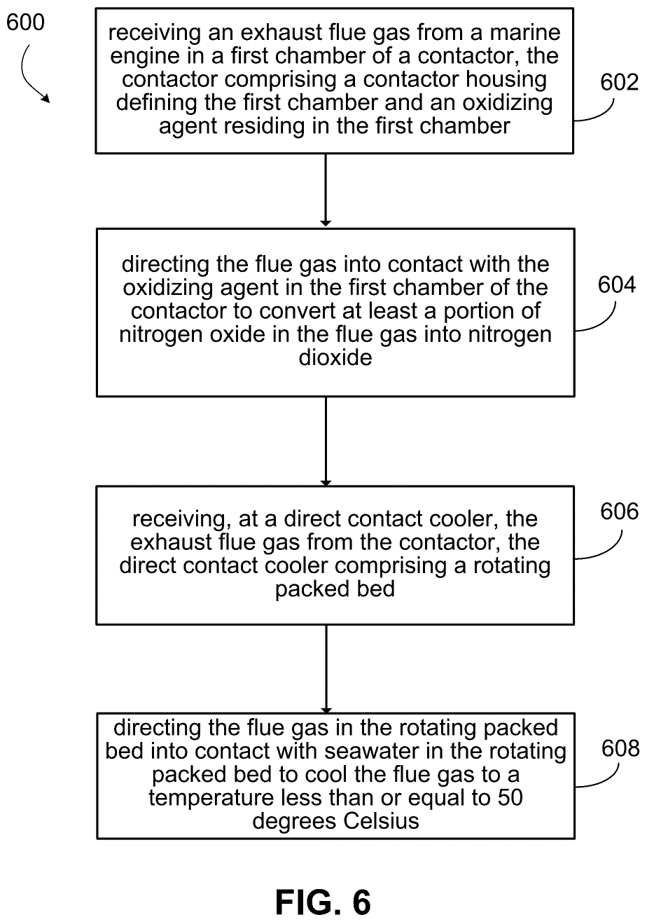

FIG. 6 is a flowchart describing another example method 600 for conditioning a flue gas from a marine vessel. The example method 600 can be performed by the example gas conditioning system 100 of FIG. 1, and can be used to condition flue gas from a marine vessel, such as the example marine vessel 300 of FIG. 3. At 602, an exhaust flue gas from a marine engine is received in a first chamber of a contactor. The contactor comprises a contactor housing defining the first chamber and an oxidizing agent residing in the first chamber. At 604, the flue gas is directed into contact with the oxidizing agent in the first chamber of the contactor to convert at least a portion of nitrogen oxide in the flue gas into nitrogen dioxide. At 606, the exhaust flue gas from the contactor is received at a direct contact cooler. The direct contact cooler comprises a rotating packed bed. At 608, the flue gas in the rotating packed bed is directed into contact with seawater in the rotating packed bed to cool the flue gas to a temperature less than or equal to 50 degrees Celsius.

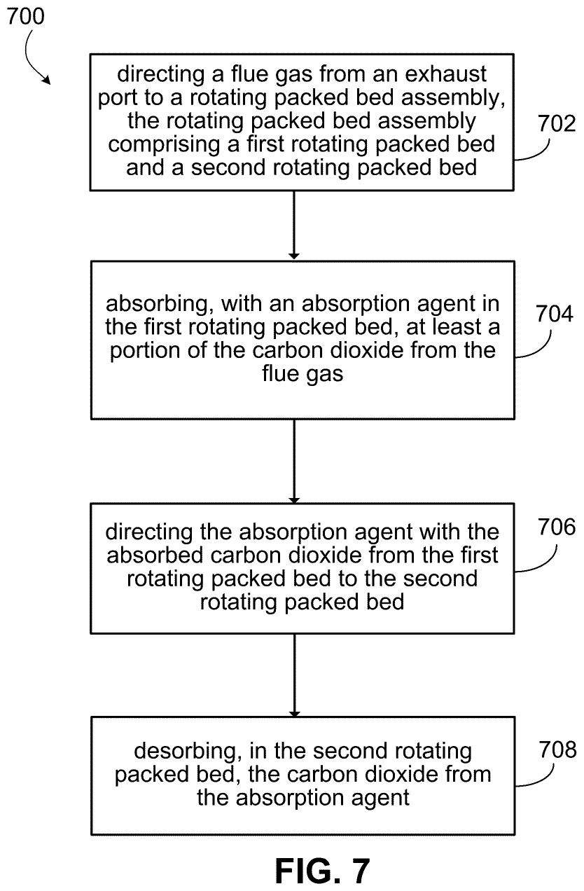

FIG. 7 is a flowchart describing another example method 700 for conditioning a glue gas. The example method 700 can be performed by the example gas conditioning system 100 of FIG. 1, and can be used to condition flue gas from a marine vessel, such as the example marine vessel 300 of FIG. 3. At 702, a flue gas is directed from an exhaust port to a rotating packed bed assembly. The rotating packed bed assembly comprises a first rotating packed bed and a second rotating packed bed. At 704, at least a portion of the carbon dioxide is absorbed from the flue gas with an absorption agent. At 706, the absorption agent with the absorbed carbon dioxide is directed from the first rotating packed bed to the second rotating packed bed. At 708, the carbon dioxide is desorbed from the absorption agent in the second rotating packed bed.

The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment. In the foregoing specification, a detailed description has been given with reference to specific exemplary embodiments. It will, however, be evident that various modifications and changes may be made thereto without departing from the broader spirit and scope of the disclosure as set forth in the claims.

What is claimed is:

1. A gas conditioning system for removing contaminants comprising nitrogen oxides and sulfur oxides from flue gas of a marine vessel, the system comprising:
an oxidizer unit comprising a first fluid inlet and a first fluid outlet, the oxidizer unit configured to receive an exhaust flue gas from a marine engine through the first fluid inlet at a temperature between 150 degrees Celsius and 550 degrees Celsius, the oxidizer unit configured to convert at least a portion of the nitrogen oxides in the flue gas into at least one of nitrogen gas or nitrogen dioxide at a temperature between 150 degrees Celsius and 550 degrees Celsius; and
a direct contact cooler comprising a second fluid inlet fluidly connected to the first fluid outlet of the oxidizer unit, a housing defining a cooling chamber, and a second fluid outlet, the direct contact cooler configured to direct the flue gas into contact with seawater residing in the cooling chamber and to cool the flue gas to a temperature less than or equal to 60 degrees Celsius, wherein the seawater is configured to remove the nitrogen dioxide and sulfur dioxide from the flue gas in the cooling chamber.

2. The gas conditioning system of claim 1, wherein the oxidizer unit is configured to receive the exhaust flue gas from the marine engine through the first fluid inlet at a temperature between 150 degrees Celsius and 350 degrees Celsius, and the oxidizer unit configured to convert the at least a portion of the nitrogen oxides in the flue gas into the at least one of nitrogen gas or nitrogen dioxide at a temperature between 150 degrees Celsius and 350 degrees Celsius.

3. The gas conditioning system of claim 1, wherein the direct contact cooler is configured to cool the flue gas to a temperature less than or equal to 50 degrees Celsius.

4. The gas conditioning system of claim 1, wherein the oxidizer unit is configured to receive the exhaust flue gas from the marine engine through the first fluid inlet at a temperature between 150 degrees Celsius and 310 degrees Celsius, and the oxidizer unit configured to convert the at least a portion of the nitrogen oxides in the flue gas into the at least one of nitrogen gas or nitrogen dioxide at a temperature between 150 degrees Celsius and 310 degrees Celsius.

5. The gas conditioning system of claim 1, wherein the oxidizer unit is further configured to convert at least a portion of the sulfur oxides in the flue gas into sulfur dioxide at the temperature between 150 degrees Celsius and 550 degrees Celsius, and
the direct contact cooler configured to separate the nitrogen dioxide and sulfur dioxide from the flue gas in the cooling chamber.

6. The gas conditioning system of claim 1, wherein the oxidizer unit comprises a housing defining an oxidizing chamber and an oxidizing agent residing in the oxidizing chamber, the oxidizing agent configured to directly contact the exhaust flue gas.

7. The gas conditioning system of claim 6, wherein the oxidizing agent comprises a solution of sodium chlorite, hydrogen peroxide, or sodium hypochlorite, where the solution is configured to contact the flue gas and convert at least a portion of nitrogen oxide in the flue gas into at least one of nitrogen gas or nitrogen dioxide.

8. The gas conditioning system of claim 1, wherein the oxidizer unit comprises a selective catalytic reduction unit configured to convert the portion of the nitrogen oxides into at least one of nitrogen gas or nitrogen dioxide at the temperature between 150 degrees Celsius and 550 degrees Celsius.

9. The gas conditioning system of claim 8, further comprising an adsorption unit comprising a third fluid inlet fluidly connected to the second fluid outlet of the direct contact cooler, the adsorption unit configured to receive the flue gas from the direct contact cooler and remove at least a portion of remaining nitrogen oxides from the flue gas from the direct contact cooler.

10. The gas conditioning system of claim 9, wherein the adsorption unit comprises at least one adsorption bed, the gas conditioning system is configured to direct the flue gas from the third fluid inlet through the at least one adsorption bed, and the adsorption bed is configured to reduce a nitrogen oxide content from the flue gas to less than 50 parts per million.

11. The gas conditioning system of claim 10, wherein and the adsorption bed is configured to reduce a nitrogen oxide content from the flue gas to less than 10 parts per million.

12. The gas conditioning system of claim 10, wherein the adsorption unit comprises two adsorption beds.

13. The gas conditioning system of claim 8, wherein the selective catalytic reduction unit comprises a second housing defining a second chamber, and a compound inlet configured to introduce a mist of a compound solution into the second chamber, the first fluid inlet configured to direct the flue gas into contact with the compound solution in the second chamber.

14. The gas conditioning system of claim 13, wherein the compound solution comprises urea or ammonia.

15. The gas conditioning system of claim 13, wherein the selective catalytic reduction unit comprises a catalyst disposed in the second chamber, the catalyst configured to contact the flue gas and the mist of compound solution.

16. The gas conditioning system of claim 1, further comprising a filter positioned upstream of the first fluid inlet, the filter configured to remove particulate matter and volatile hydrocarbons from the flue gas.

17. The gas conditioning system of claim 16, wherein the filter is directly coupled to the oxidizer unit at the first fluid inlet of the oxidizer unit.

18. The gas conditioning system of claim 1, further comprising a blower unit positioned between a marine engine and the first fluid inlet of the oxidizer unit, the blower unit configured to direct the flue gas to the oxidizer unit and increase a pressure of the flue gas.

19. The gas conditioning system of claim 1, further comprising a blower unit positioned downstream of the direct contact cooler, the blower unit configured to generate a partial vacuum in a flowpath of the flue gas through the oxidizer and the direct contact cooler and promote flow of the flue gas through the oxidizer and the direct contact cooler and toward the blower unit.

20. The gas conditioning system of claim 1, wherein the direct contact cooler comprises a rotating packed bed comprising:
the housing enclosing the cooling chamber,
a rotor drum disposed within the housing and rotatable about a rotational axis,
a seawater inlet fluidly connected to the rotor drum,
a seawater outlet fluidly connected to the housing,
the second fluid inlet fluidly connected to the housing, and
the second fluid outlet fluidly connected to the rotor drum,
wherein the flue gas is directed from the second fluid inlet to the second fluid outlet, and seawater is directed from the seawater inlet to the seawater outlet.

21. The gas conditioning system of claim 20, wherein the flue gas is disposed in countercurrent flow with the seawater within the rotor drum when the rotating packed bed is in use.

22. The gas conditioning system of claim 1, wherein the direct contact cooler comprises a seawater inlet to direct the seawater into the cooling chamber, the seawater configured to remove at least a portion of sulfur dioxide and nitrogen dioxide from the flue gas in the cooling chamber.

23. The gas conditioning system of claim 1, further comprising a water treatment system fluidly connected to the direct contact cooler to receive the seawater from the direct contact cooler, the water treatment system comprising a membrane and a dosification system configured to adjust the pH of the seawater to be above 6.5.

24. The gas conditioning system of claim 1, further comprising a rotating packed bed assembly fluidly connected to the direct contact cooler to receive the flue gas from the direct contact cooler, the rotating packed bed assembly comprising:
a first rotating packed bed comprising an absorption agent configured to absorb at least a portion of carbon dioxide from the flue gas, and
a second rotating packed bed configured to receive the absorption agent from the first rotating packed bed and desorb the absorbed carbon dioxide from the absorption agent.

25. The gas conditioning system of claim 24, wherein the absorption agent comprises a liquid solvent.

26. The gas conditioning system of claim 25, wherein the liquid solvent comprises an amine solvent.

27. The gas conditioning system of claim 26, wherein the rotating packed bed assembly further comprises a water wash station fluidly connected to the first rotating packed bed, the water wash station configured to wash the flue gas from the first rotating packed bed with water.

28. The gas conditioning system of claim 27, wherein the water wash station comprises a packed cylinder or a rotating packed bed.

29. The gas conditioning system of claim 24, further comprising a storage system fluidly connected to the second rotating packed bed and comprising a compressor and a storage tank, the storage system configured to receive desorbed carbon dioxide, compress the desorbed carbon dioxide with the compressor, and store the carbon dioxide in the storage tank.

30. A gas conditioning system for removing contaminants comprising nitrogen oxides and sulfur oxides from flue gas of a marine vessel, the system comprising:
an oxidizer unit comprising a first fluid inlet and a first fluid outlet, the oxidizer unit configured to receive an exhaust flue gas through the first fluid inlet, the oxidizer unit configured to convert at least a portion of the nitrogen oxides in the flue gas into at least one of nitrogen gas or nitrogen dioxide; and
a direct contact cooler comprising a rotating packed bed to direct the flue gas into contact with seawater and cool the flue gas to a temperature less than or equal to 60 degrees Celsius, wherein the seawater is configured to remove the nitrogen dioxide and sulfur dioxide from the flue gas, the rotating packed bed comprising:
a housing enclosing a cooling chamber,
a rotor drum disposed within the housing and rotatable about a rotational axis,
a seawater inlet fluidly connected to the rotor drum,
a seawater outlet fluidly connected to the housing,
a second fluid inlet fluidly connected to the housing and to the first fluid outlet of the oxidizer unit, and
a second fluid outlet fluidly connected to the rotor drum,
wherein the flue gas is directed from the second fluid inlet to the second fluid outlet, the seawater is directed from the seawater inlet to the seawater outlet.

31. The gas conditioning system of claim 30, wherein the flue gas is disposed in countercurrent flow with the seawater within the rotor drum when the rotating packed bed is in use.

32. The gas conditioning system of claim 30, wherein the seawater inlet directs the seawater into the rotor drum, and the seawater is configured to remove at least a portion of the sulfur dioxide and the nitrogen dioxide from the flue gas in the cooling chamber.
